(19) United States
(12) Patent Application Publication
(10) Pub. No.: US 2025/0358802 A1
(43) Pub. Date: Nov. 20, 2025

(54) TECHNIQUES FOR ZERO POWER INTERNET OF THINGS COMMUNICATION

(71) Applicant: QUALCOMM Incorporated, San Diego, CA (US)

(72) Inventors: Zhikun WU, Beijing (CN); Yuchul KIM, San Diego, CA (US); Ahmed ELSHAFIE, San Diego, CA (US); Krishna Kiran MUKKAVILLI, San Diego, CA (US); Tingfang JI, San Diego, CA (US); Peter GAAL, San Diego, CA (US); Huilin XU, Temecula, CA (US); Seyedkianoush HOSSEINI, San Diego, CA (US); Yu ZHANG, San Diego, CA (US); Linhai HE, San Diego, CA (US); Hwan Joon KWON, San Diego, CA (US)

(21) Appl. No.: 18/871,365

(22) PCT Filed: Aug. 3, 2022
(86) PCT No.: PCT/CN2022/109964

§ 371 Date: Dec. 3, 2024

(51) Int. Cl. H04W 72/0453; H04L 5/00; H04L 5/14; H04L 27/26

(52) U.S. Cl. CPC H04W 72/0453; H04L 5/0012; H04L 5/1469; H04L 27/2605

(57) ABSTRACT

Certain aspects of the present disclosure provide techniques for zero power internet of things communication. An example method performed by a user equipment (UE) includes receiving configuration information for communicating with one or more zero power internet of things (ZP-IoT) devices, wherein the configuration information indicates a first ZP-IoT frequency range for ZP-IoT communications. The method may also include transmitting, using a first resource sharing scheme, uplink (UL) signals to a first ZP-IoT device in the first ZP-IoT frequency range, wherein the first resource sharing scheme used to transmit the UL signals differs from a second resource sharing scheme for transmitting downlink (DL) signals to the first ZP-IoT device.

### BACKGROUND

### Field of the Disclosure

Aspects of the present disclosure relate to wireless communications, and more particularly, to techniques for zero power internet of things communication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment. The method includes receiving configuration information for communicating with one or more zero power internet of things (ZP IoT) devices, wherein the configuration information indicates a first ZP IoT frequency range for ZP IoT communications; and transmitting, using a first resource sharing scheme, uplink (UL) signals to a first ZP IoT device in the first ZP IoT frequency range, wherein the first resource sharing scheme used to transmit the UL signals differs from a second resource sharing scheme for transmitting downlink (DL) signals to the first ZP IoT device.

Another aspect provides a method for wireless communication by a network entity. The method includes transmitting, to a user equipment, configuration information for communicating with one or more ZP IoT devices, wherein the configuration information indicates a first ZP IoT frequency range for ZP IoT communications; and transmitting, using a second resource sharing scheme, DL signals to a first ZP IoT device in the first ZP IoT frequency range, wherein the second resource sharing scheme used to transmit the one or more DL signals differs from a first resource sharing scheme for transmitting UL signals to the first ZP IoT device.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A illustrates a radio frequency identification (RFID) system.

FIG. 5B illustrates an example topographies for circuitry of an RFID reader and for the energy harvesting circuitry.

FIGS. 6A, 6B, and 6C illustrate different deployment scenarios for ZP-IoT communication.

FIGS. 7A and 7B illustrate different interference scenarios associated with ZP-IoT communication.

FIG. 8 depicts a process flow for communications in a network between a network entity, a user equipment, a first ZP-IoT device, and a second ZP-IoT device.

FIG. 9 illustrates an example of a resource sharing scheme for ZP-IoT communication that may be used when transmitting the uplink signals using a time division duplexing scheme.

FIG. 10 illustrates an example of a resource sharing scheme for ZP-IoT communication that may be used when transmitting the downlink signals using a time division duplexing scheme.

FIG. 11 illustrates an example of a guard period that may be used for ZP-IoT communication.

FIGS. 12A and 12B illustrate timing advance examples associated with fifth generation new radio communication and ZP-IoT communication.

FIG. 13 illustrates an example of a first resource sharing scheme and a second resource sharing scheme for ZP-IoT communication that may be used when transmitting the uplink signals using a frequency division duplexing scheme.

FIG. 14 illustrates of a plurality of ZP-IoT frequency ranges that may be used for ZP-IoT communication.

FIG. 15 illustrates reconfiguration of ZP-IoT frequency ranges t for ZP-IoT communication.

FIG. 16A illustrates user equipment support for communication on different bandwidth parts.

FIG. 16B illustrates ZP-IoT device support for communication on a ZP-IoT frequency band.

FIG. 17 illustrates different frequency ranges within a ZP-IoT frequency band that may be supported by different ZP-IoT devices for ZP-IoT communication

FIG. 18 illustrates frequency hopping for ZP-IoT communication.

FIG. 19 depicts a method for wireless communications.

FIG. 20 depicts a method for wireless communications.

FIG. 21 depicts aspects of an example communications device.

FIG. 22 depicts aspects of an example communications device.

### DETAILED DESCRIPTION

Aspects of the present disclosure provide apparatuses, methods, processing systems, and computer-readable mediums for zero power internet of things communication.

In some cases, certain devices known as zero power passive internet of things (ZP-IoT) devices may be capable of harvesting energy from one or more wireless energy sources, such as RF signals, thermal energy, solar energy, etc. In some cases, when RF signals are used to harvest energy a first device, such as a reader device, may transmit an energy signal to a second device, such as a PIOT device. The second device may then harvest energy from the energy signal (e.g., using energy harvesting circuitry) and use this harvested energy to power one or more other components of the second device. After a sufficient amount of energy is accumulated, the second device may begin to modulate the energy signal with transmission bits and transmit the energy signal back to the first device, known as a backscatter signal or backscatter communication.

In some cases, ZP-IoT devices may coexist in a wireless network with other, more-advanced types of devices, such as fifth generation (5G) NR-based devices, which may not operate based on energy signals. In some cases, due to a high transmission power needed to communicate with the ZP-IoT devices, when these ZP-IoT devices are co-deployed with the other more-advanced types of devices, communication with the ZP-IoT devices may cause significant interference to these other devices within the wireless network.

In some cases, to avoid such interference, a frequency range for ZP-IoT communication could be limited. However, limiting the frequency range for ZP-IoT communication may not be desirable since different ZP-IoT devices may not all be configured to communicate on the same ZP-IoT frequency range. Further, due to the simplistic nature of ZP-IoT devices, it may not be possible to reconfigure operating bandwidths of ZP-IoT devices. As such, reconfiguring the frequency range for ZP-IoT communication from a first frequency range to a second frequency range (e.g., to avoid interference with other devices in the wireless network) may present issues as it might end up excluding some ZP-IoT devices from being able to communicate. Moreover, even if a larger operating bandwidth dedicated specifically for ZP-IoT communication is configured to support more ZP-IoT devices, there may be instances in which not all of the frequency spectrum in the operating bandwidth is used by ZP-IoT devices, leading to wasted time-frequency resources within the wireless network.

Accordingly, aspects of the present disclosure provide techniques for improving ZP-IoT communication within wireless networks. In some cases, the techniques presented herein may help to reduce the interference associated with ZP-IT communication discussed above as well as to improve spectrum efficiency. For example, to help reduce the interference associated with ZP-IoT communication, the techniques presented herein may include using a different resource sharing scheme when transmitting downlink ZP-IoT transmissions to ZP-IoT devices as compared to when uplink ZP-IoT transmissions are transmitted to ZP-IoT devices. Further, to help improve spectrum efficiency and reduce wasted time-frequency resources, the techniques presented herein involve the configuration of different frequency bands that may be used by different ZP-IoT devices for communication. Further, the different frequency bands may be indicated to a reader device (e.g., an NR-UE), allowing the reader device to communicate with the different ZP-IoT devices on the different frequency bands and to more efficiently use frequency spectrum, thereby reducing wasted time-frequency resources.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

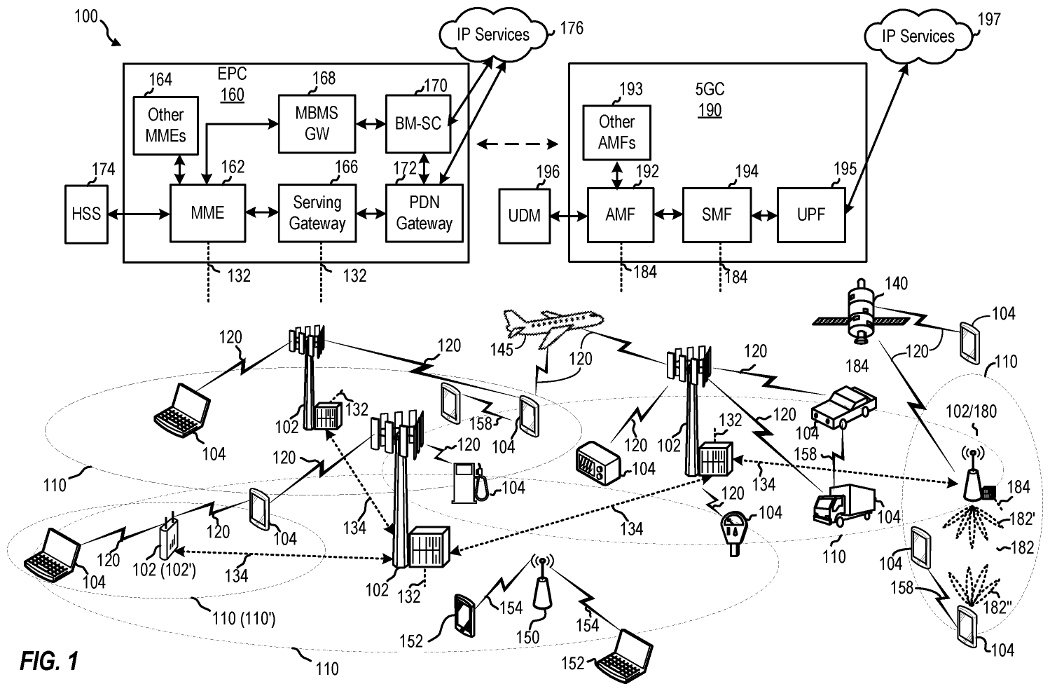

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

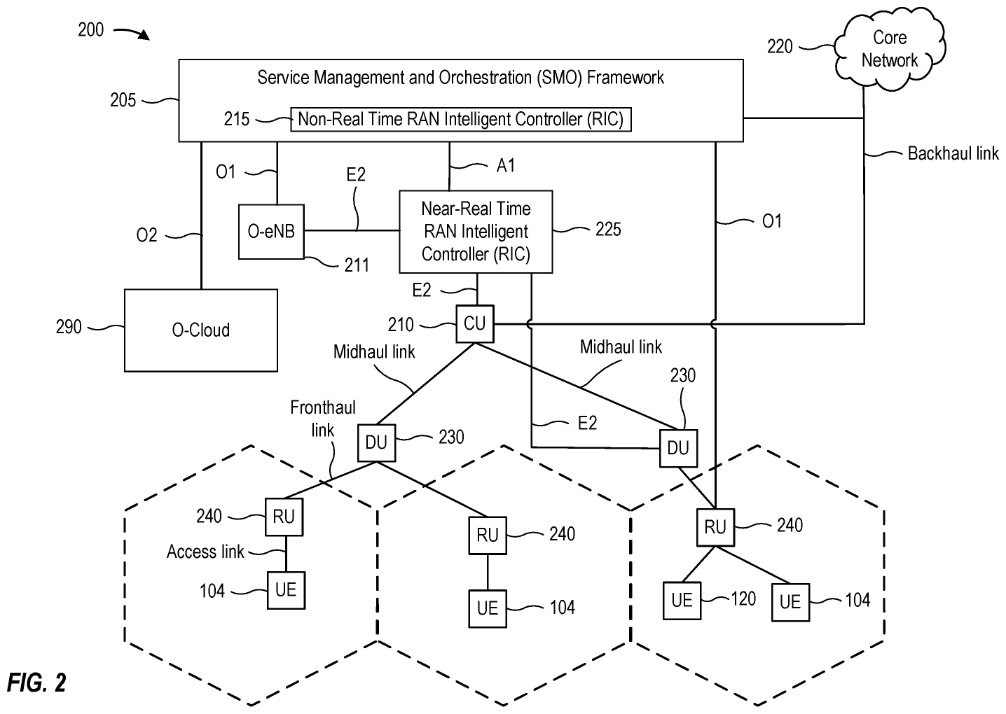

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

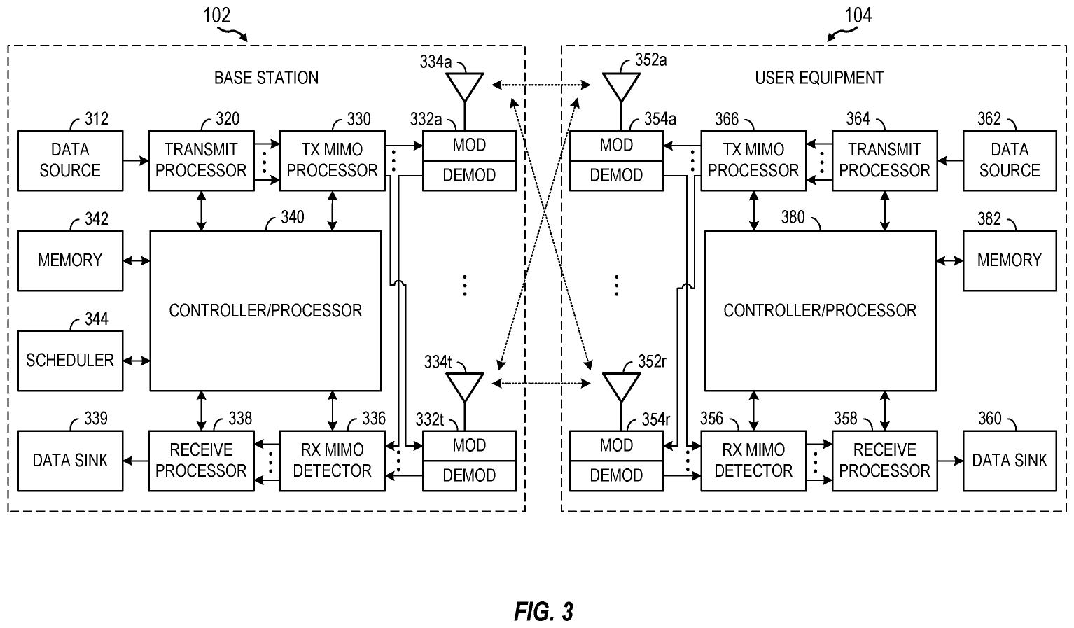

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

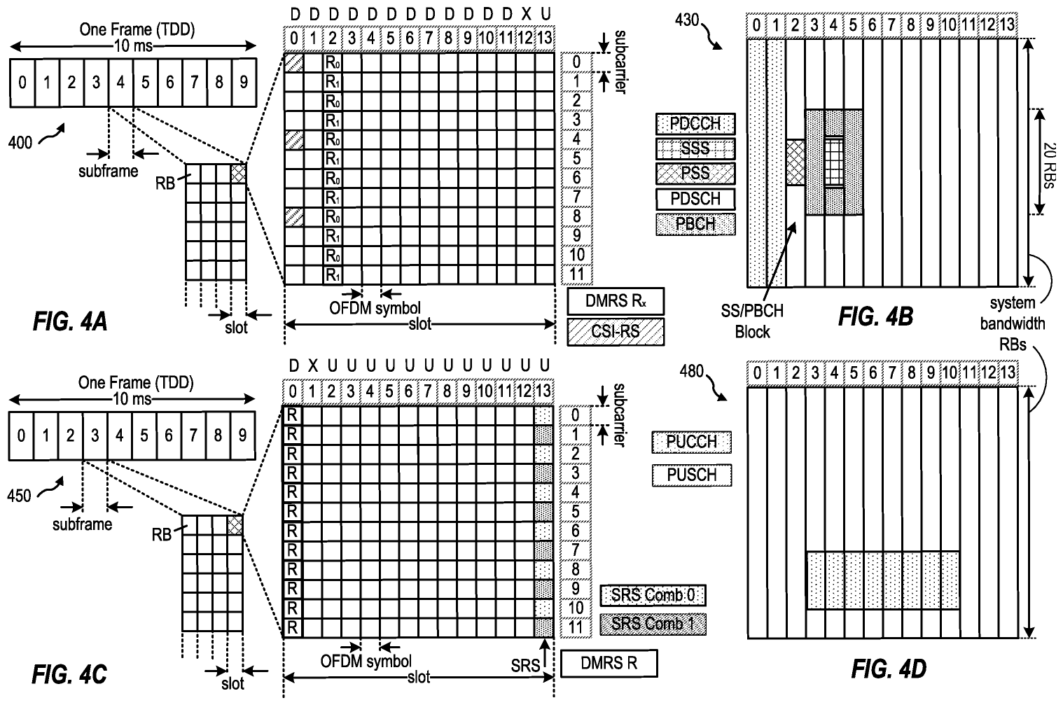

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in Radio Frequency Identification Systems

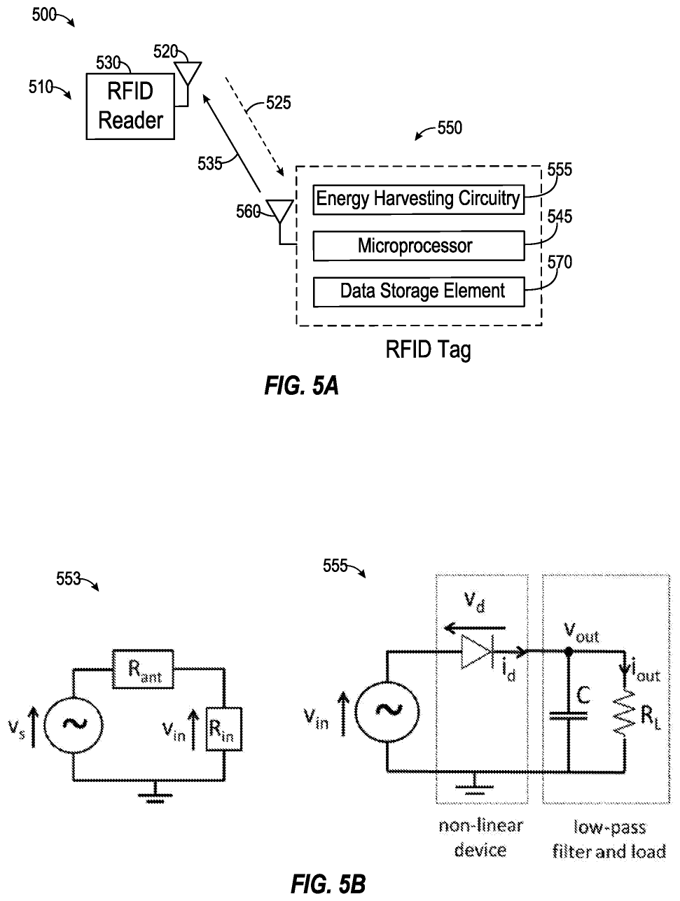

FIG. 5A shows a radio frequency identification (RFID) system 500. As shown, the RFID system 500 includes an RFID reader 510 and an RFID tag 550. The RFID reader 510 may also be referred to as an interrogator or a scanner. The RFID tag 550 may also be referred to as an RFID label or an electronics label.

The RFID reader 510 includes an antenna 520 and an electronics unit 530. The antenna 520 radiates signals transmitted by the RFID reader 510 and receives signals from RFID tags and/or other devices. The electronics unit 530 may include a transmitter and a receiver for reading RFID tags such as the RFID tag 550. The same pair of transmitter and receiver (or another pair of transmitter and receiver) may support bi-directional communication with wireless networks, wireless devices, etc. The electronics unit 530 may include processing circuitry (e.g., a processor) to perform processing for data being transmitted and received by the RFID reader 510.

As shown, the RFID tag 550 includes an antenna 560 and a data storage element 570. The antenna 560 radiates signals transmitted by the RFID tag 550 and receives signals from the RFID reader 510 and/or other devices. The data storage element 570 stores information for the RFID tag 550, for example, in an electrically erasable programmable read-only memory (EEPROM) or another type of memory. The RFID tag 550 may also include an electronics unit that can process the received signal and generate the signals to be transmitted. The RFID tag 550 may be a passive RFID tag having no battery. In this case, induction may be used to power the RFID tag 550. For example, in some cases, a magnetic field from a signal transmitted by RFID reader 510 may induce an electrical current in RFID tag 550, which may then operate based on the induced current. The RFID tag 550 can radiate its signal in response to receiving a signal from the RFID reader 510 or some other device.

In one example, the RFID tag 550 may be read by placing the RFID reader 510 within close proximity to the RFID tag 550. The RFID reader 510 may radiate a first signal 525 via the antenna 520. In some cases, the first signal 525 may be known as an interrogation signal or energy signal. In some cases, energy of the first signal 525 may be coupled from the RFID reader antenna 520 to RFID tag antenna 560 via magnetic coupling and/or other phenomena. In other words, the RFID tag 550 may receive the first signal 525 from RFID reader 510 via antenna 560 and energy of the first signal 525 may be harvested using energy harvesting circuitry 555 and used to power the RFID tag 550.

For example, energy of the first signal 525 received by the RFID tag 550 may be used to power a microprocessor 545 of the RFID tag 550. The microprocessor 545 may, in turn, retrieve information stored in a data storage element 570 of the RFID tag 550 and transmit the retrieved information via a second signal 535 using the antenna 560. For example, in some cases, the microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to the RFID reader 510. The RFID reader 510 may receive the second signal 535 from the RFID tag 550 via antenna 520 and may process (e.g., demodulate) the received signal to obtain the information of the data storage element 570 sent in the second signal 535.

In some cases, the RFID system 500 may be designed to operate at 13.56 MHz or some other frequency (e.g., an ultra-high frequency (UHF) band at 900 MHZ). The RFID reader 510 may have a specified maximum transmit power level, which may be imposed by the Federal Communication Commission (FCC) in the United Stated or other regulatory bodies in other countries. The specified maximum transmit power level of the RFID reader 510 may limit the distance at which RFID tag 550 can be read by RFID reader 510.

FIG. 5B illustrates an example equivalent circuit 553 of the antenna 560 of and an example topography of the energy harvesting circuitry 555 of the RFID tag 550. In some cases, as illustrated in the equivalent circuit 553 of the antenna 560, a lossless antenna may be modelled as an alternating current (AC) voltage source (vₛ(t)) followed by a series antenna resistance (Rₐₙₜ) of the antenna 560. In some cases, the voltage source (vₛ(t)) may be based on an energy signal y_{rf}(t)) received from the RFID reader 510. The equivalent circuit 553 of the antenna 560 also includes an input resistance (Rᵢₙ) representing a resistance associated with the energy harvesting circuitry 555. In some cases, with perfect impedance matching, Rᵢₙ may equal Rₐₙₜ.

As shown, the energy harvesting circuitry 555 comprises a half-wave rectifier circuit configured to convert an AC input power (vᵢₙ) (e.g., received via the antenna 560) into a direct current (DC) output power (vₒᵤₜ). Further, as shown, the energy harvesting circuitry 555 comprises a diode, a capacitor (C), and a load impedance (R_{L}). The diode is configured to pass only one half of each complete sine wave of the AC voltage in order to convert it into the DC voltage. Further, as illustrated in the energy harvesting circuitry 555 in FIG. 5B, i_{d} is a current of the diode and v_{d} is a voltage of the diode. In some cases, under perfect matching, vᵢₙ(t) may be half of vₛ(t) and both can be related to the received signal energy signal (y_{rf}(t)) at the energy harvesting circuitry 555 as

$${v}_{s} ( t ) = 2 {y}_{rf} ( t ) {R}_{ant}^{\frac{1}{2}} and {v}_{i n} ( t ) = {y}_{rf} ( t ) {R}_{ant}^{\frac{1}{2}} .$$

### Aspects Related to Techniques for Zero Power Internet of Things Communication

Wireless technology is increasingly useful in industrial applications, such as ultra-reliable low-latency communication (URLLC) and machine type communication (MTC). In such domains, and others, it is desirable to support devices that are capable of harvesting energy from alternative energy sources (e.g., in lieu of or in combination with a battery or other energy storage device, such as a capacitor). For example, in some cases, these devices may not include a local power storage component and may instead harvest energy from things such as RF signals, thermal energy, solar energy, etc. In some cases, these devices may be known as passive IoT (PIOT) devices or more generally as zero power internet of things (ZP-IoT) devices. ZP-IoT devices may employ RFID-type technology and, as such, may not include a local power source. Instead, ZP-IoT devices may harvest energy from radio signals emitted from a reader device, such as a network entity or a user equipment (UE), for performing data collection, transmission and distributed computing.

Wireless standards bodies have developed specifications to support narrow band IoT (NB-IoT)/MTC devices and reduced capability (RedCap) devices for MTC use cases. RedCap-type devices may be associated with a reduced operating bandwidth, a reduced maximum number of MIMO layers, and a relaxation of a maximum downlink modulation order. However, while current wireless technology, such as fifth generation (5G) new radio (NR), is able to support the NB-IoT and RedCap devices, this technology may not currently be able to efficiently support the most pervasive RFID-type of sensors (e.g., ZP-IoT devices) in many future use cases, such as asset management, logistics, warehousing and manufacturing. For example, supporting ZP-IoT devices using current 5G NR technology would require these ZP-IoT devices to have more complex circuitry, requiring additional cost and maintenance associated with battery replacement, which may not be feasible in these future use cases. As such, additional wireless communication technology may be necessary to support and manage communication with ZP-IoT-type devices.

As noted above, ZP-IoT devices may be capable of harvesting energy from one or more wireless energy sources, such as RF signals, thermal energy, solar energy, etc. In some cases, when RF signals are used to harvest energy a first device, such as a reader device (e.g., BS 102, a disaggregated BS as described with respect to FIG. 2, UE 104, or any other device described herein capable of transmitting wireless signals), may transmit an energy signal to a second device, such as a ZP-IoT device (e.g., UE 104, RFID tag 550, etc.). The second device may then harvest energy from the energy signal (e.g., using energy harvesting circuitry, such as energy harvesting circuitry 555 illustrated in FIGS. 5A and 5B) and use this harvested energy to power one or more other components of the second device. In some cases, a portion of the harvested energy may be used to charge a local energy storage device of the second device for later use (i.e., the harvested energy may be stored in the local power storage component). After a sufficient amount of energy is accumulated, the second device may begin to reflect the energy signal radiated onto the second device, known as a backscatter signal or backscatter communication. When reflecting the energy signal, the second device may modulate a particular on-off pattern, corresponding to a set of transmission bits, onto the energy signal. The first device (e.g., the reader device) detects and demodulates the reflected pattern, thereby obtaining the set of transmission bits.

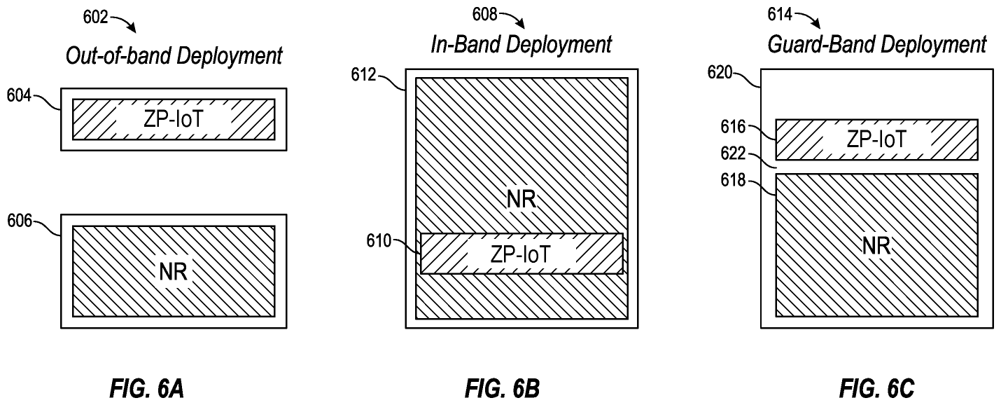

In some cases, ZP-IoT devices may coexist in a wireless network with other types of devices, such as 5G NR-based devices, which may not operate based on energy signals. As such, different types of deployment scenarios may be used to support ZP-IoT communication and 5G NR communication, as illustrated in FIGS. 6A, 6B, and 6C. For example, FIG. 6A illustrates a first deployment type 602 for communicating with a ZP-IoT device. As shown, the first deployment type 602 includes an out-of-band or standalone deployment in which frequency resources for PIOT communication and frequency resources used for 5G NR communication are separated into different frequency bands or bandwidth parts (BWPs). For example, as shown in FIG. 6A, the first deployment type 602 (e.g., out-of-band deployment) includes a first frequency band 604 for 5G NR communication and a separate second frequency band 606 having a dedicated carrier for PIOT communication.

FIG. 6B illustrates a second deployment type 608 for communicating with a ZP-IoT device. As shown, the second deployment type 608 includes an in-band deployment in which the frequency resources for PIOT communication are defined within a frequency band used for 5G NR communication. For example, as shown in FIG. 6B, a set frequency resources for PIOT communication 610 are defined within a frequency band 612 used for 5G NR communication. In other words, a portion of frequency resources allocated for 5G NR communication may be repurposed for PIOT communication.

FIG. 6C illustrates a third deployment type 614 for communicating with a ZP-IoT device. As shown, the third deployment type 614 include a guard band deployment in which the frequency resources for PIOT communication and frequency resources for 5G NR communication are defined within a same frequency band or BWP but separated by a guard band. For example, as shown in FIG. 6C, a first set frequency resources for PIOT communication 616 and a second set of frequency resources 618 are defined within a frequency band 620 and are separated by a guard band 622.

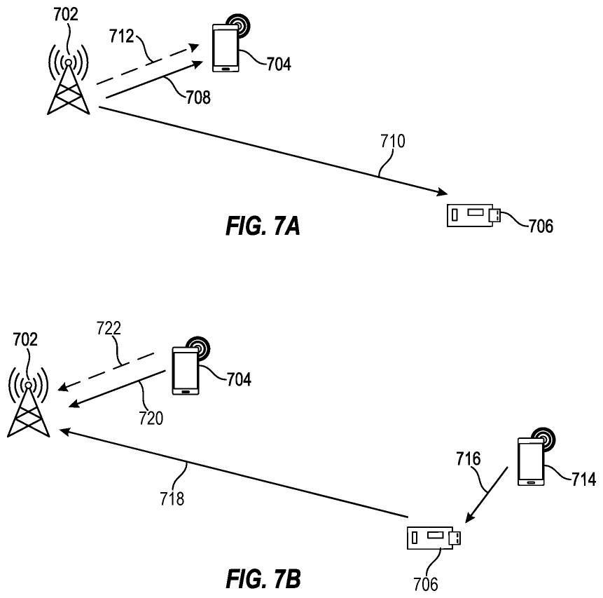

In some cases, when ZP-IoT devices are co-deployed with NR UEs in a wireless communication network, the NR UEs may experience, at least in a downlink (DL) direction, significant interference due to ZP-IoT communication. FIGS. 7A and 7B illustrate two interference scenarios associated with ZP-IoT communication. For example, FIG. 7A illustrates a first interference scenario that may occur in the downlink (DL) when a network entity acts as a reader device for communicating with a ZP-IoT device. For example, as shown, FIG. 7A includes a network entity 702 (e.g., BS 102, a disaggregated BS as described with respect to FIG. 2), an NR-UE 704, and a ZP-IoT device 706. The network entity 702 transmits downlink (DL) signals 708 and 710 to the NR-UE 704 and the ZP-IoT device 706, respectively. In some cases, due to a high transmission power associated with the DL signals 710 transmitted to the ZP-IoT device 706, the DL signals 710 may cause interference to the DL signals 708 transmitted to the NR-UE 704, causing the NR-UE 704 to not be able to properly receive the DL signals 708.

FIG. 7B illustrates a second interference scenario that may occur in the uplink (UL) when an NR-UE acts as the reader device for communicating with a ZP-IoT device. For example, as shown, FIG. 7B again includes the network entity 702, the NR-UE 704, and the ZP-IoT device 706. Further, as shown, FIG. 7B also include another NR-UE 714 that is capable of communicating using ZP-IoT communication with the ZP-IoT device 706. For example, as shown, the NR-UE 714 transmits uplink (UL) signals 716 to the ZP-IoT device 706. The ZP-IoT device 706 may harvest energy from these UL signals and may transmit backscatter signals 718 to the network entity 702. In some cases, however, UL signals 720 transmitted by the NR-UE 704 may cause interference 722 to the backscatter signals 718. In some cases, the interference 722 caused by the UL signals 720 transmitted by the NR-UE 704 may not be as significant as the interference 712 caused by the DL signals 710 transmitted to the ZP-IoT device 706 due to the relatively lower transmission power associated with the UL signals 720 transmitted by the NR-UE 704. Additionally, the network entity 702 may have stronger processing capabilities to cancel any interference associated with the backscatter signals 718.

In some cases, a frequency range for ZP-IoT communication may be tens of megahertz (MHz) and sometimes even more than 100 MHz. In some cases, for certain ZP-IoT devices (e.g., operating at a BW of 110 MHz), if a center frequency between 902-928 MHz, for example, is used for ZP-IoT communication in a wireless network, this ZP-IoT communication may be strongly interfered by other signals within a remaining bandwidth of the wireless network, such as 5G NR signals. For example, the ZP-IoT device may require up to −10 dBm received power in order to receive an energy signal. However, due to the relatively simply nature of ZP-IoT devices, these ZP-IoT devices may not have interference cancelation capabilities to remove the strong interference from the other signals within the wireless network.

In some cases, to avoid such interference, a portion of the bandwidth of the wireless network may be dedicated only to the frequency range for ZP-IoT, such as tens of megahertz (e.g., 40 MHz). However, dedicating a portion of the bandwidth in the wireless network to ZP-IoT communication may lead to wasted time-frequency resources in the wireless network as there may be instances in which not all of the frequency spectrum within the dedicated portion is used by ZP-IoT devices. In such cases, it may be more reasonable for ZP-IoT devices and ZP-IoT communication to coexist with 5G NR devices and communication. For example, 100 MHz of the bandwidth within the wireless network may be allocated to 5G NR communication and 40 MHz of the bandwidth may be allocated to ZP-IoT communication. In some cases, when 5G communication and ZP-IoT communication coexist within the bandwidth (e.g., 100 MHz), there may be instances in which the frequency range for the ZP-IoT communication may need to be adjusted to avoid interference with the 5G NR communication. However, due to the simplistic nature of ZP-IoT devices, it may not be possible to reconfigure the frequency range for the ZP-IoT communication (e.g., a center frequency for a ZP-IoT reception bandwidth may not be able to be re-configured), leading to scheduling difficulties between 5G communication and ZP-IoT communication as well as interference, wasted time-frequency resources, and power resources.

Accordingly, aspects of the present disclosure provide techniques for improving ZP-IoT communication within wireless networks. In some cases, the techniques presented herein may help to reduce the interference associated with ZP-IoT communication discussed above as well as to improve spectrum efficiency. For example, to help reduce the interference associated with ZP-IoT communication, the techniques presented herein may include using a different resource sharing scheme when transmitting DL ZP-IoT transmissions to ZP-IoT devices as compared to when UL ZP-IT transmissions are transmitted to ZP-IoT devices. Further, to help improve spectrum efficiency and reduce wasted time-frequency resources, the techniques presented herein involve the configuration of different frequency bands that may be used by different ZP-IoT devices for communication. Further, the different frequency bands may be indicated to a reader device (e.g., an NR-UE), allowing the reader device to communicate with the different ZP-IoT devices on the different frequency bands and to more efficiently use frequency spectrum, thereby reducing wasted time-frequency resources. In some cases, these techniques may apply to all of the different deployment scenarios illustrated in FIGS. 6A, 6B, and 6C.

### Example Operations of Entities in a Communications Network

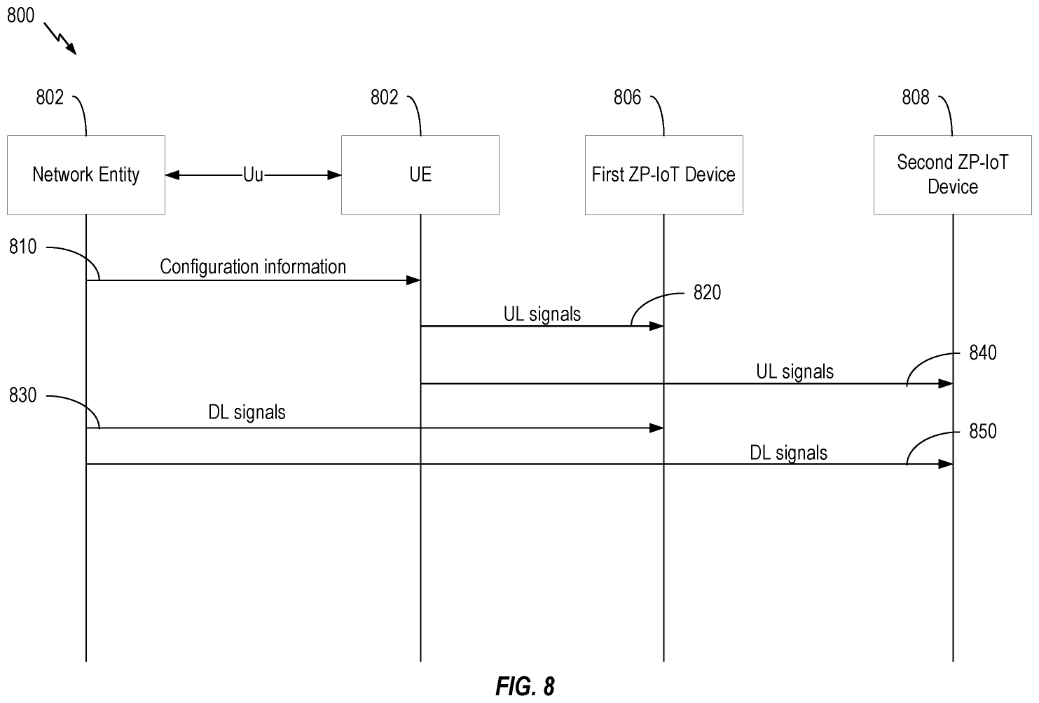

FIG. 8 depicts a process flow illustrating operations 800 for communications in a network between a network entity 802, a UE 804, a first ZP-IoT device 806, and a second ZP-IoT device 808. In some aspects, the first ZP-IoT device 806 and second ZP-IoT device 808 may be examples of the ZP-IoT device 706 illustrated in FIG. 7, the RFID tag 550 illustrated in FIG. 5A, or the UE 104 depicted and described with respect to FIGS. 1 and 3. In some aspects, the network entity 802 may be an example of a reader device that is capable of ZP-IoT communication (e.g., transmitting energy signals and receiving backscatter signals), such as BS 102 depicted and described with respect to FIGS. 1 and 3 or a disaggregated base station depicted and described with respect to FIG. 2. Similarly, the UE 804 may be an example of a reader device that is capable of ZP-IoT communication (e.g., transmitting energy signals and receiving backscatter signals), such as UE 104 depicted and described with respect to FIGS. 1 and 3. However, in other aspects, UE 104 may be another type of wireless communications device and BS 102 may be another type of network entity or network node, such as those described herein.

As shown, operations 800 begin in step 810 with the network entity 802 transmitting, to the UE 804, configuration information for communicating with one or more ZP-IoT devices, such as the first ZP-IoT device 806. In some cases, the configuration information may indicate a first ZP-IoT frequency range for ZP-IoT communications.

In step 820, the UE 804 transmits, using a first resource sharing scheme, UL signals to at least the first ZP-IoT device 806 in the first ZP-IoT frequency range. In some cases, to improve spectrum efficiency, the first ZP-IoT frequency range may be shared with other 5G NR communications (e.g., orthogonal frequency-division multiplexing (OFDM) communications). To facilitate this sharing and to avoid or reduce interference associated with ZP-IoT communication and the other 5G NR communications, a first resource sharing scheme may be used to transmit the UL signals. In some cases, this first resource sharing scheme may differ from a second resource sharing scheme for transmitting DL signals to the first ZP-IoT device 806 or to other devices (e.g., UEs) in the network.

For example, as shown in step 830, the network entity 802 may use the second resource sharing scheme to transmit the DL signals to the first ZP-IoT device 806 (or other ZP-IoT devices within the network, such as the second ZP-IoT device 808).

In some cases, the UE 804 may transmit the UL signals to first ZP-IoT device 806 using a particular duplexing scheme. Additionally, in some cases, the network entity 802 may also use the particular duplexing scheme for transmitting the DP signals to the first ZP-IoT device 806. For example, in some cases, the duplexing scheme may include a time division duplexing (TDD) scheme in which the UL signals and the DL signals are separated into different time occasions, such as UL time occasions for the UL signals and DL time occasions for the DL signals.

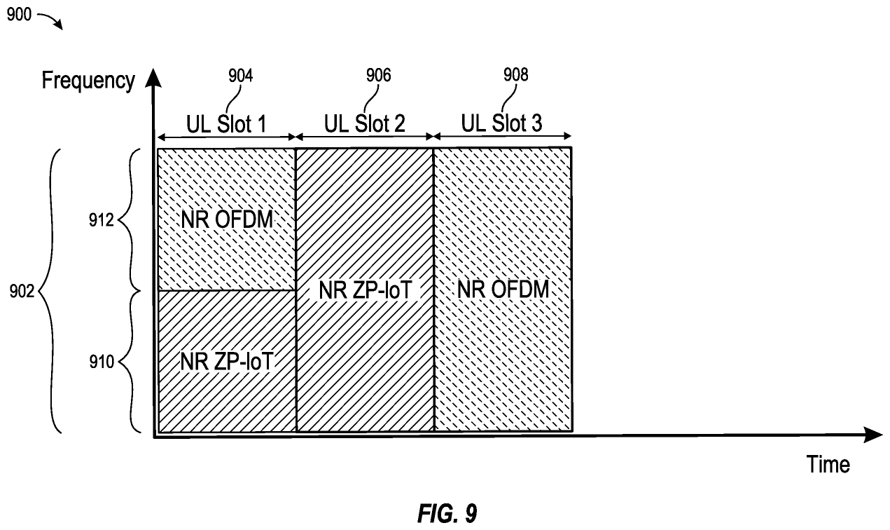

Accordingly, when transmitting the UL signals in step 820 of FIG. 8 using the TDD scheme, the first resource sharing scheme that may be used in the UL time occasions may include an UL time division multiplexing (TDM) scheme and an UL frequency division multiplexing (FDM) scheme. FIG. 9 includes an example of the TDM+FDM resource sharing schemes that may be used when transmitting the UL signals using the TDD scheme.

FIG. 9 includes a time-frequency grid 900 for a TDD scheme illustrating an allocation of resources for UL ZP-IoT communications and UL OFDM communications. As shown, resources for the UL ZP-IoT communications and the UL OFDM communications may be allocated within a ZP-IoT frequency band 902 and a plurality of UL time occasions, such as the UL time slot 904, the UL time slot 906, and the UL time slot 908. While the plurality of UL time occasions are illustrated as time slots in FIG. 9, it should be understood that the plurality of time occasions could be any type of time occasions, including symbols, frames, etc.

Further, as noted above, when transmitting the UL signals to the first ZP-IoT device 806, the UE 804 may use a first resource sharing scheme including the UL TDM scheme and the UL FDM scheme. For example, as shown in FIG. 9, when transmitting the UL signals within the UL time slot 904, the UL FDM scheme may be used, allowing the UL signals (e.g., ZP-IoT signals) transmitted to the first ZP-IoT device 806 to share the ZP-IoT frequency band with UL OFDM signals. For example, as shown, the UL signals transmitted to the first ZP-IoT device 806 may be FDM multiplexed and transmitted in a first ZP-IoT frequency range 910 of the ZP-IoT frequency band 902 in UL time slot 904 while the UL OFDM signals (e.g., transmitted by other UEs to the network entity 802) may be FDM multiplexed and transmitted in a frequency range for OFDM communications 912 of the ZP-IoT frequency band 902 in UL time slot 904.

Conversely, UL transmissions in UL time slot 906 and UL time slot 908 may be transmitted using the TDM scheme. For example, as shown, in order to share the ZP-IoT frequency band 902 with the UL OFDM signals, the UL signals transmitted to the first ZP-IoT device 806 may be TDM multiplexed and transmitted within the ZP-IoT frequency band 902 of the UL time slot 906 while the UL OFDM signals (e.g., transmitted by other UEs to the network entity 802) may be TDM multiplexed and transmitted within the ZP-IoT frequency band 902 of the UL time slot 908.

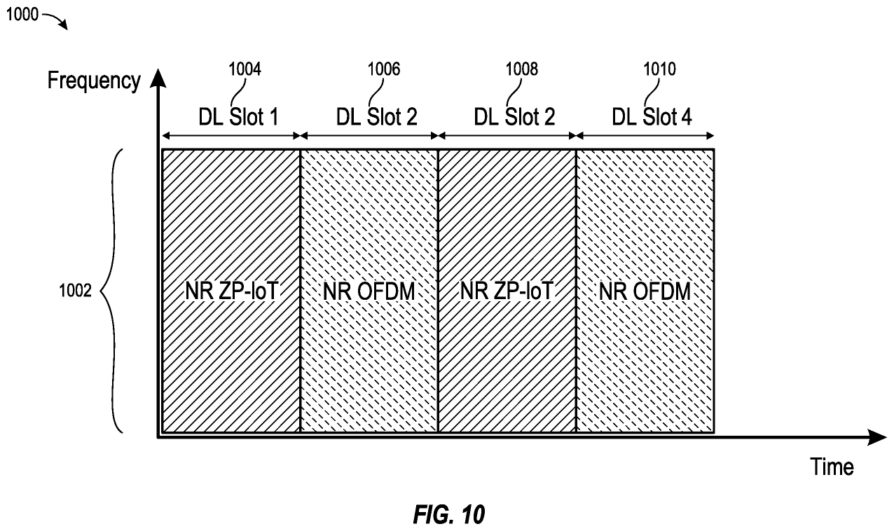

As noted above, in step 830 of FIG. 8, the network entity 802 may use the second resource sharing scheme to transmit the DL signals to the first ZP-IoT device 806. An example of the second resource sharing scheme is illustrated in FIG. 10. For example, FIG. 10 includes a time-frequency grid 1000 for a TDD scheme illustrating an allocation of resources for UL ZP-IoT communications and UL OFDM communications. As shown, resources for the UL ZP-IoT communications and the UL OFDM communications may be allocated within a ZP-IoT frequency band 1002 and a plurality of DL time occasions, such as the DL time slot 1004, the DL time slot 1006, the DL time slot 1008, and the DL time slot 1010. While the plurality of DL time occasions are illustrated as time slots in FIG. 10, it should be understood that the plurality of DL time occasions could be any type of time occasions, including symbols, frames, etc.

When transmitting the DL signals in step 830 of FIG. 8 using the TDD scheme, the second resource sharing scheme that may be used in the DL time occasions may include a DL TDM scheme. In some cases, the second resource sharing scheme may not include a DL FDM scheme. Accordingly, as shown in FIG. 10, when transmitting the DL signals using the DL TDM scheme, the DL signals transmitted to the first ZP-IoT device 806 may be time multiplexed with other DL OFDM signals within the DL time slot 1004, the DL time slot 1006, the DL time slot 1008, and the DL time slot 1010. For example, as shown, the DL signals transmitted to the first ZP-IoT device 806 may be transmitted in the DL time slot 1004 and the DL time slot 1008 while the other DL OFDM signals may be transmitted in the DL time slot 1006 and the DL time slot 1010. Accordingly, by time multiplexing the DL signals transmitted to the first ZP-IoT device 806 and the other DL OFDM signals (e.g., to other UEs in the network), the DL signals transmitted to the first ZP-IoT device 806 and the other DL OFDM signals may share the ZP-IoT frequency band 1002 without interfering with each other.

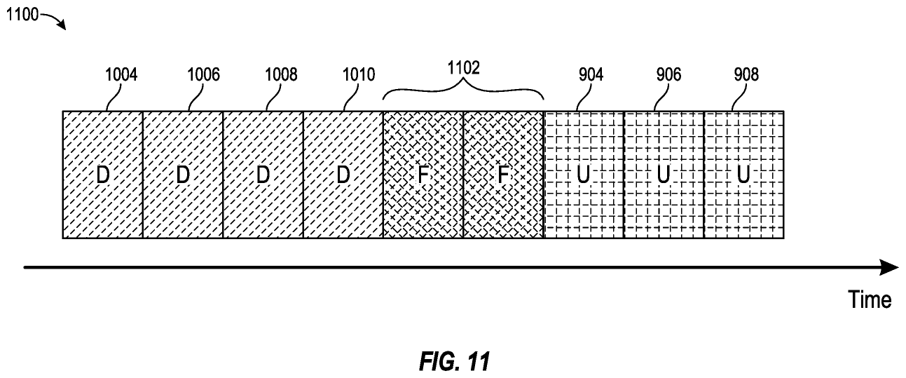

In some cases, a guard period may be configured between DL time occasions (e.g., used by the network entity 802 to transmit the DL signals to the first ZP-IoT device 806) and the UL time occasions (e.g., used by the UE 804 to transmit the UL signals to the first ZP-IoT device 806) when TDD is used. Accordingly, in some cases, the configuration information transmitted by the network entity 802 to the UE 804 in step 810 of FIG. 8 may include an indication of a guard period configured between the UL signals to the first ZP-IoT device 806 in the UL time occasions (e.g., the UL time slot 904, the UL time slot 906, and the UL time slot 908) and the DL signals to the first ZP-IoT device 806 in the DL time occasions (the DL time slot 1004, the DL time slot 1006, the DL time slot 1008, and the DL time slot 1010). An example of this guard period is illustrated in FIG. 11.

For example, FIG. 11 illustrates a resource allocation 1100 including a plurality of DL time occasions (the DL time slot 1004, the DL time slot 1006, the DL time slot 1008, and the DL time slot 1010) and a plurality of UL time occasions (e.g., the UL time slot 904, the UL time slot 906, and the UL time slot 908). The plurality of DL time occasions and plurality of UL time occasions may be used for ZP-IoT communication, such as for transmitting DL signals and UL signals to the first ZP-IoT device 806. While the plurality of DL time occasions and the plurality of UL time occasions are described as being time slots, it should be understood that the plurality of time occasions could be any type of time occasions, including symbols, frames, etc.

Further, as shown, the resource allocation 1100 includes a guard period 1102 located between the plurality of DL time occasions and plurality of UL time occasions. The guard period 1102 may include one or more guard symbols (e.g., 1-14 symbols) or slots to allow a switch between transmission of the DL signals and transmission of the UL signals. In the example shown in FIG. 11, the guard period 1102 is composed of a plurality of flexible symbols that can be configured for either UL transmissions, DL transmissions, or not used for transmissions. In some cases, for ZP-IoT communication, a minimum time for a guard period may be approximately 0.581 milliseconds.

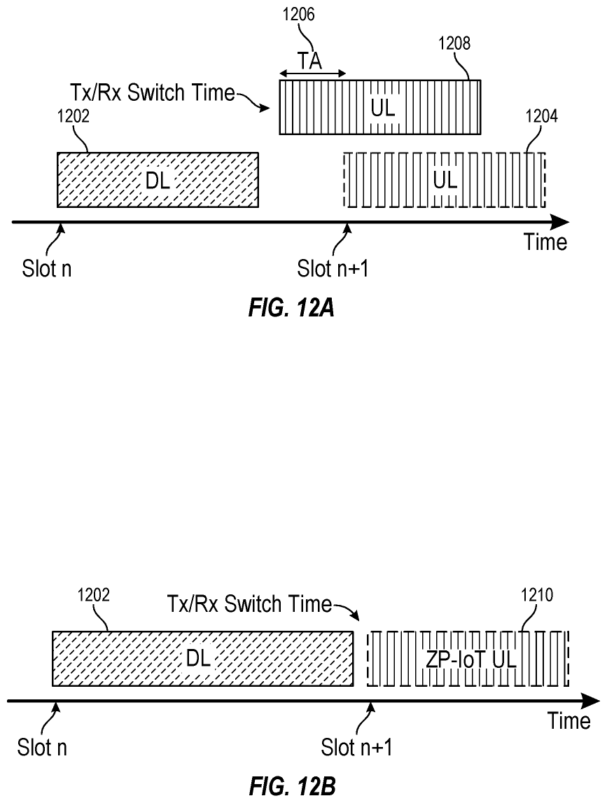

In some cases, when TDD is used for transmitting signals within the network, an UL timing advance and offset (e.g., N_{TA}+N_{TA_offset}) may be used by the UE 804 to ensure that UL NR OFDM transmissions (e.g., by the UE 804 and other UEs in the network) align with receive timing at the network entity 802. FIG. 12A illustrates an example timing advance that may be used for UL OFDM transmissions. For example, as shown, DL OFDM transmissions 1202 may be transmitted within slot n. Thereafter, the UE 804 may be scheduled to transmit UL OFDM transmissions 1204 in slot n+1. However, in some cases, the UE 804 may receive a time advance command from the network entity 802, including a time advance 1206 (and, in some cases, a time offset). The time advance may be used by the UE 804 to advance the UL OFDM transmissions 1204 in time, as shown at 1208.

However, in some cases, when transmitting UL signals to the first ZP-IoT device 806 usage of the UL timing advance may be optional (e.g., since the UL signals need not be aligned when arriving at the first ZP-IoT device 806). For example, as shown in FIG. 12B, DL OFDM transmissions 1202 may be transmitted within slot n. Thereafter, the UE 804 may be scheduled to transmit UL ZP-IoT transmissions 1210 in slot n+1 (e.g., the UL transmissions to the first ZP-IoT device 806). However, in the example shown FIG. 12B, the UE 804 may be configured to transmit the UL ZP-IoT transmission 1210 without using an UL timing advance. In other cases, the UE 804 may be configured to transmit the UL ZP-IoT transmission 1210 using a first UL timing advance different from a second UL timing advance (e.g., 1206) used for the UL OFDM transmissions 1204.

As noted above, the network entity 802 and the UE 804 may transmit the DI signals and the UL signals, respectively, to first ZP-IoT device 806 using a particular duplexing scheme. In some cases, the duplexing scheme comprises a frequency division duplexing (FDD) scheme in which the UL signals and the DL signals are separated into different frequency bands within a time slot. In some cases, the different frequency ranges comprise an UL frequency band for the UL signals and a DL frequency band for the DL signals. In some cases, the first ZP-IoT frequency range in which the UL signals are transmitted by the UE 804 may be included within the UL frequency band.

In some cases, when transmitting the UL signals in step 820 of FIG. 8 using the FDD scheme in the UL frequency band, the first resource sharing scheme that may be used in the first UL frequency range to transmit the UL signals may include an UL TDM scheme and an UL FDM scheme. In some cases, when transmitting the DL signals in step 830 of FIG. 8 using the FDD scheme in the UL frequency band, the second resource sharing scheme may include a DL TDM scheme. In some cases, the second resource sharing scheme may not include a DL FDM scheme.

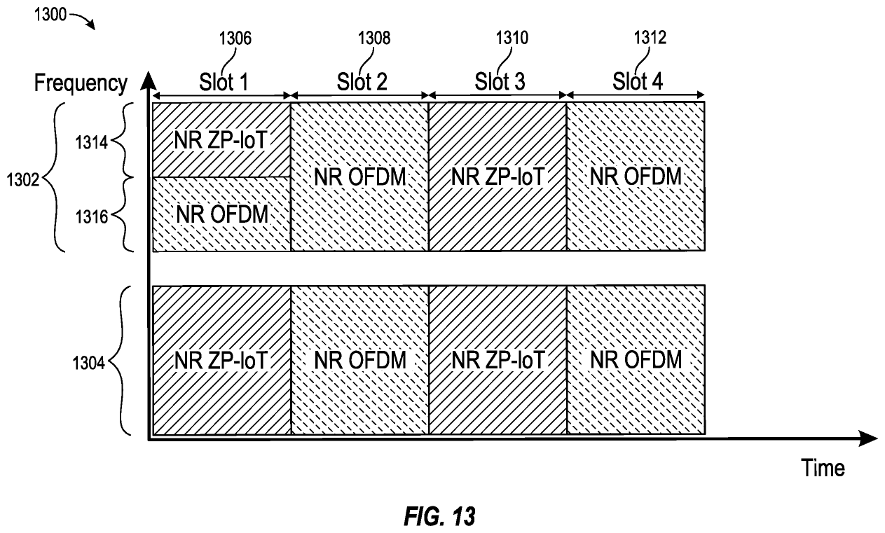

FIG. 13 includes an example, for the FDD scheme, of the TDM+FDM resource sharing scheme for transmitting the UL signals and the TDM resource sharing scheme for transmitting the DL signals. For example, as shown, FIG. 13 includes a time-frequency grid 1300 that includes an UL frequency band 1302 for UL transmissions, a DL frequency band 1304 for DL transmissions, and a plurality of time occasions for transmitting the DL transmissions and UL transmissions. As shown, the plurality of time occasions include a first time slot 1306, a second time slot 1308, a third time slot 1310, and a fourth time slot 1312. While the plurality of time occasions are described as being time slots, it should be understood that the plurality of time occasions could be any type of time occasions, including symbols, frames, etc.

As noted above, when transmitting the UL signals to the first ZP-IoT device 806, the UE 804 may use the first resource sharing scheme including the UL TDM scheme and the UL FDM scheme. For example, as shown in FIG. 13, when transmitting the UL signals within the first time slot 1306 of the UL frequency band 1302, the UL FDM scheme may be used, allowing the UL signals (e.g., ZP-IoT signals) transmitted to the first ZP-IoT device 806 by the UE 804 to share the UL frequency band with UL OFDM signals. For example, as shown, the UL signals transmitted by the UE 804 to the first ZP-IoT device 806 may be FDM multiplexed and transmitted in a first ZP-IoT frequency range 1314 of the UL frequency band 1302 in the first time slot 1306 while the UL OFDM signals (e.g., transmitted by other UEs to the network entity 802) may be FDM multiplexed and transmitted in a frequency range for OFDM communications 1316 of the ZP-IoT frequency band 902 in the first time slot 1306.

Conversely, UL transmissions in second time slot 1308, third time slot 1310, and the fourth time slot 1312 of the UL frequency band 1302 may be transmitted using the TDM scheme. For example, as shown, in order to share the UL frequency band 1302 with the UL OFDM signals, the UL signals transmitted by the UE 804 to the first ZP-IoT device 806 may be TDM multiplexed and transmitted within the UL frequency band 1302 of the third time slot 1310 while the UL OFDM signals (e.g., transmitted by other UEs to the network entity 802) may be TDM multiplexed and transmitted within the UL frequency band 1302 of the second time slot 1308 and the fourth time slot 1312.

Further, as noted above, in step 830 of FIG. 8, the network entity 802 may use the second resource sharing scheme (e.g., the DL TDM resource sharing scheme) to transmit the DL signals to the first ZP-IoT device 806. For example, when transmitting the DL signals using the DL TDM scheme, the DL signals transmitted to the first ZP-IoT device 806 may be time multiplexed with other DL OFDM signals within the DL frequency band 1304 of the first time slot 1306, the second time slot 1308, the third time slot 1310, and the fourth time slot 1312. For example, as shown, the DL signals transmitted to the first ZP-IoT device 806 may be transmitted in the DL frequency band 1304 of the first time slot 1306 and the third time slot 1310 while the other DL OFDM signals may be transmitted in the DL frequency band 1304 of the second time slot 1308 and the fourth time slot 1312. Accordingly, by time multiplexing the DL signals transmitted to the first ZP-IoT device 806 and the other DL OFDM signals (e.g., to other UEs in the network), the DL signals transmitted to the first ZP-IoT device 806 and the other DL OFDM signals may share the ZP-IoT frequency band 1002 without interfering with each other.

In some cases, the network entity 802 and UE 804 may be configured to transmit the DL signals and the UL signals, respectively, to one or more second ZP-IoT devices, such as the second ZP-IoT device 808, as shown in steps 840 and 850 in FIG. 8. In some cases, because it is difficult to reconfigure ZP-IoT frequency ranges for ZP-IoT communication (e.g., since different ZP-IoT devices may support different frequency ranges for ZP-IoT communication), it may be advantageous to define a plurality of frequency ranges specifically for ZP-IoT communication so that different ZP-IoT devices may communicate using different frequency ranges. In some cases, a reader device (e.g., network entity 802 or UE 804) performing the ZP-IoT communication may be configured with or may choose frequency ranges, from the plurality of ZP-IoT frequency ranges, to perform the ZP-IoT communication.

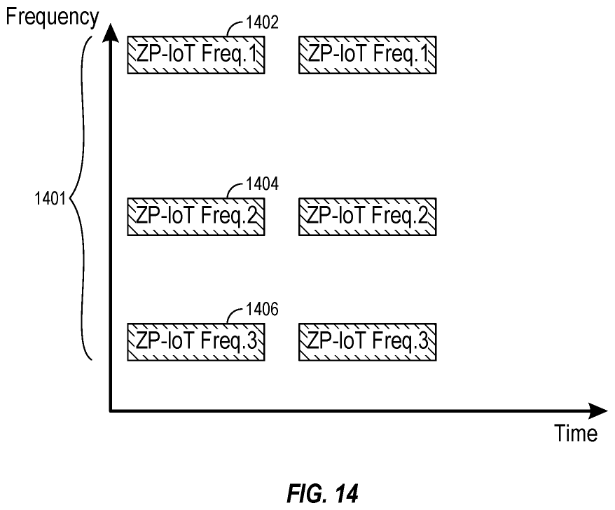

For example, as noted above, the network entity 802 and the UE 804 may be configured to transmit the DL signals and the UL signals to the first ZP-IoT device 806 in a first ZP-IoT frequency range. Further, one or more additional ZP-IoT frequency ranges may be configured for and supported by the one or more second ZP-IoT devices (e.g., the second ZP-IoT device 808) for ZP-IoT communication different from the first ZP-IoT frequency range supported by the first ZP-IoT device 806. In such cases, the configuration information transmitted in step 810 by the network entity 802 to the UE 804 may indicate the one or more additional ZP-IoT frequency ranges. In some cases FIG. 14 provides an illustration of these additional ZP-IoT frequency ranges.

FIG. 14 illustrates a time-frequency resource grid 1400 including a plurality of ZP-IoT frequency ranges that may be used for ZP-IoT communication. For example, as shown, the time-frequency resource grid 1400 includes a first ZP-IoT frequency range 1402, a second ZP-IoT frequency range 1404, and a third ZP-IoT frequency range 1406. As shown, the first ZP-IoT frequency range 1402, the second ZP-IoT frequency range 1404, and the third ZP-IoT frequency range 1406 may be defined within a ZP-IoT frequency band 1401. In some cases, the ZP-IoT frequency band 1401 may have a bandwidth of 4 gigahertz (GHz). Additionally, in some cases, the first ZP-IoT frequency range 1402 may have a bandwidth of 10 megahertz (MHz), the second ZP-IoT frequency range 1404 may have a bandwidth of 20 MHZ, and the third ZP-IoT frequency range 1406 may have a bandwidth of 30 MHz.

In some cases, for example, the network entity 802 and the UE 804 may use the first ZP-IoT frequency range 1402 for transmitting the DL signals and UL signals, respectively, to the first ZP-IoT device 806. Additionally, in some cases, the network entity 802 and the UE 804 may use the second ZP-IoT frequency range 1404 for transmitting the DL signals and UL signals, respectively, to the second ZP-IoT device 808. In some cases, the third ZP-IoT frequency range 1406 may be used for transmitting DL signals or UL signals to another ZP-IoT device (or the first ZP-IoT device 806 or the second ZP-IoT device 808, if supported).

In some cases, reconfiguration of the plurality of ZP-IoT frequency ranges may be possible, but may be subject to certain timing constraints. Additionally, while ZP-IoT communication may be possible on a plurality of ZP-IoT frequency ranges, the plurality of ZP-IoT frequency ranges used for the ZP-IoT communication may need to be selected or configured from a set of candidate frequency ranges.

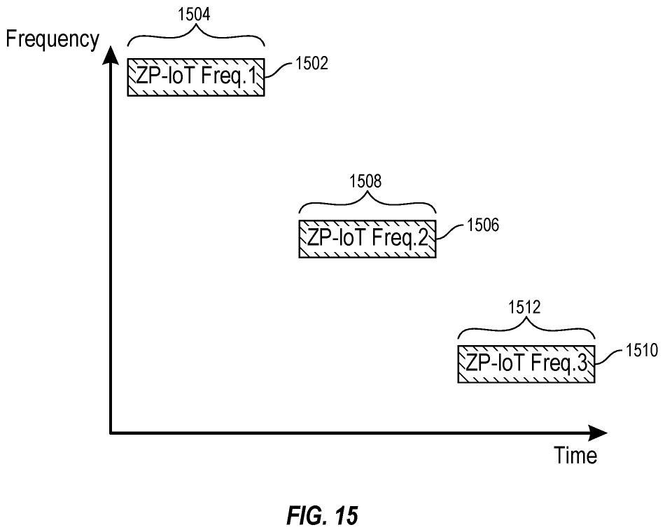

For example, as illustrated in FIG. 15, the network entity 802 and/or the UE 804 may use ZP-IoT frequency range, such as a first ZP-IoT frequency rage 1502, to transmit the DL signals and UL signals, respectively, for a first period of time 1504. Thereafter, the ZP-IoT frequency range may be reconfigured to a second ZP-IoT frequency range 1506. In such cases, the network entity 802 and/or the UE 804 may then use the second ZP-IoT frequency range 1506 to transmit the DL signals and UL signals, respectively, for a second period of time 1508. Further, as illustrated, the ZP-IoT frequency range may again be reconfigured to a third ZP-IoT frequency range 1510. In such cases, the network entity 802 and/or the UE 804 may then use the third ZP-IoT frequency range 1510 to transmit the DL signals and UL signals, respectively, for a third period of time 1512. In some cases, the first period of time 1504, the second period of time 1508, and the third period of time 1512 may be defined as a number of time units, such as hours, days, etc.

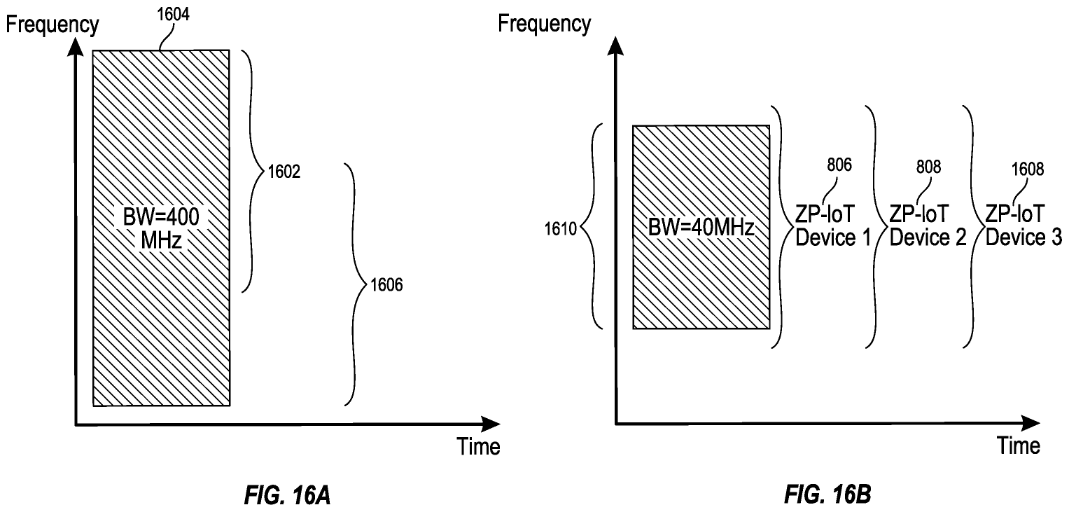

In some cases, different UEs (e.g., UE 104, UE 804, etc.) in a 5G NR system may have the ability to receive on different frequency ranges within a 5G NR frequency band. For example, as illustrated in FIG. 16A, a first UE may support reception on a first bandwidth part (BWP) 1602 in the 5G NR frequency band 1604 while a second UE may support reception on a second BWP 1606 in the 5G NR frequency band 1604. In some cases, the first UE and second UE may also have the ability to periodically change their reception capability. For example, in some cases, the first UE may have the ability to switch from receiving on the first BWP 1602 to receiving on the second BWP 1606. Similarly, the second UE may have the ability to switch from receiving on the second BWP 1606 to receiving on the first BWP 1602.

In some cases, these techniques may also be used for ZP-IoT communication. However, when applied to ZP-IoT communication, additional conditions may need to be satisfied. For example, for a certain frequency band, ZP-IoT devices intended for communication in this frequency band, may need to have good reception ability within the entire frequency band. For example, as shown in FIG. 16B, the first ZP-IoT device 806, the second ZP-IoT device 808, and a third ZP-IoT device 1608 may support communication within a ZP-IoT frequency band 1610. Further, in some cases, the first ZP-IoT device 806, the second ZP-IoT device 808, and the third ZP-IoT device 1608 may support ZP-IoT communication on different frequency ranges within the ZP-IoT frequency band 1610. However, in such cases, the first ZP-IoT device 806, the second ZP-IoT device 808, and the third ZP-IoT device 1608 may still need to have good reception ability within the entire ZP-IoT frequency band 1610, as illustrated in FIG. 16.

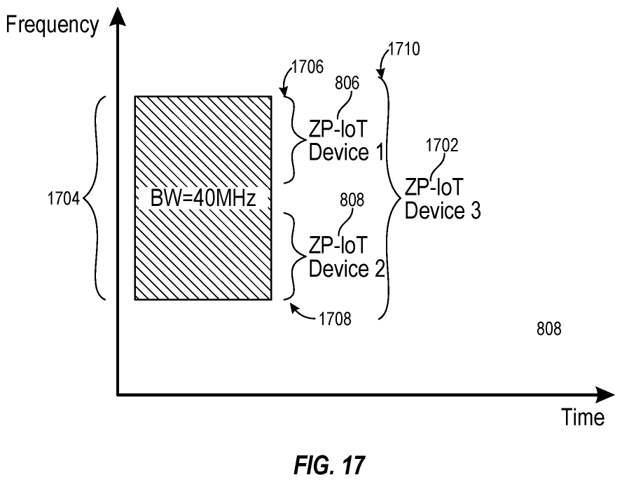

FIG. 17 provides an illustration of different frequency ranges within a ZP-IoT frequency band that may be supported by different ZP-IoT devices for ZP-IoT communication. For example, as shown, the first ZP-IoT device 806, the second ZP-IoT device 808, and a third ZP-IoT device 1702 may support ZP-IoT communication on different frequency ranges within the ZP-IoT frequency band 1704. For example, the first ZP-IoT device 806 may support ZP-IoT communication in a first ZP-IoT frequency range 1706 within the ZP-IoT frequency band 1704. The second ZP-IoT device 808 may support ZP-IoT communication in a second ZP-IoT frequency range 1708 within the ZP-IoT frequency band 1704. The third ZP-IoT device 1702 may support ZP-IoT communication in a third ZP-IoT frequency range 1710 within the ZP-IoT frequency band 1704.

In some cases, when a particular frequency band is configured for ZP-IoT communication and different ZP-IoT devices support ZP-IoT communication in different frequency ranges within the particular frequency band configured for the ZP-IoT communication, the different frequency ranges supported by the different ZP-IoT devices may be indicated to a reader device so that the reader device knows which ZP-IoT frequency ranges to use to communicate with which ZP-IoT device. For example, when the reader device is a user equipment, such as UE 804, the network entity 802 may transmit an indication of the different frequency ranges supported by the different ZP-IoT devices (e.g., the first ZP-IoT device 806 and the second ZP-IoT device 808) within the configuration information transmitted in step 810 of FIG. 8.

In some cases, when different ZP-IoT devices support different ZP-IoT frequency ranges within a ZP-IoT frequency band, the reader device (e.g., network entity 802 or UE 804) may use frequency hopping to ensure that ZP-IoT communication with the different ZP-IoT communication devices is possible. For example, with reference to the example shown in FIG. 17, to facilitate communicating with the first ZP-IoT device 806, the second ZP-IoT device 808, and the third ZP-IoT device 1702, the network entity 802 and UE 804 may use frequency hopping to transmit and receive signals within each of the different ZP-IoT frequency ranges (e.g., the first ZP-IoT frequency range 1706, the second ZP-IoT frequency range 1708, and the third ZP-IoT frequency range 1710). For example, in some cases, the network entity 802 and UE 804 may transmit the DL signals and/or UL signals to the first ZP-IoT device 806 within the first ZP-IoT frequency range 1706. Thereafter, the network entity 802 and UE 804 may then switch to the second ZP-IoT frequency range and transmit the DL signals and/or UL signals to the second ZP-IoT device 808 within the second ZP-IoT frequency range 1708.

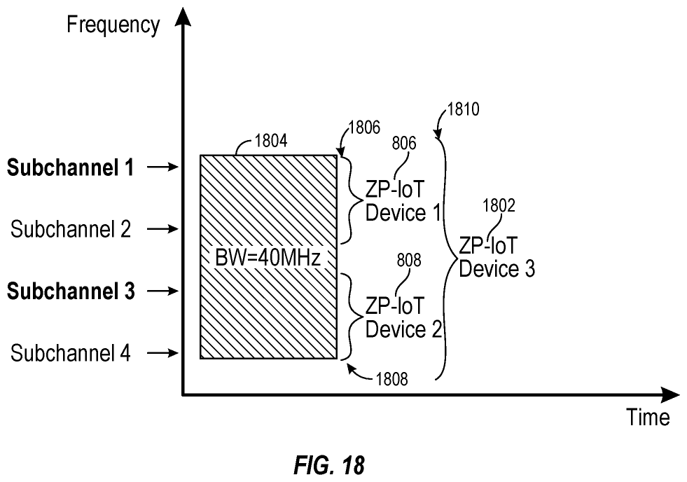

In some cases, when using frequency hopping, transmitting the DL signals/UL signals may be based on a frequency hopping pattern involving different sub-channels within the ZP-IoT frequency band defined for ZP-IoT communication. In some cases, different frequency hopping patterns may be assigned to different UEs, ZP-IoT devices, etc. so that interference may be reduced. FIG. 18 provides an illustration of these frequency hopping techniques.

For example, as illustrated in FIG. 18, as shown, the first ZP-IoT device 806, the second ZP-IoT device 808, and a third ZP-IoT device 1802 may support ZP-IoT communication on different frequency ranges within the ZP-IoT frequency band 1804. For example, the first ZP-IoT device 806 may support ZP-IoT communication in a first ZP-IoT frequency range 1806 within the ZP-IoT frequency band 1804. The second ZP-IoT device 808 may support ZP-IoT communication in a second ZP-IoT frequency range 1808 within the ZP-IoT frequency band 1804. The third ZP-IoT device 1702 may support ZP-IoT communication in a third ZP-IoT frequency range 1810 within the ZP-IoT frequency band 1804.

Further, as illustrated, the ZP-IoT frequency band 1804 includes a plurality of sub-channels, such as sub-channel 1, sub-channel 2, sub-channel 3, and sub-channel 1. Further, as can be seen, each sub-channel of the plurality of sub-channels is included within at least one of the first ZP-IoT frequency range 1806, the second ZP-IoT frequency range 1808, or the third ZP-IoT frequency range 1810. In some cases, these sub-channels may be used by the network entity 802 and UE 804 to perform frequency hopping when transmitting the DL signals and UL signals in steps 820-850 in FIG. 8 to the first ZP-IoT device 806, the second ZP-IoT device 808, and the third ZP-IoT device 1802.

For example, in some cases, the network entity and/or UE 804 may transmit the DL signals/UL signals to the first ZP-IoT device 806 using either sub-channel 1 or sub-channel 2. Similarly, the network entity and/or UE 804 may transmit the DL signals/UL signals to the second ZP-IoT device 808 using either sub-channel 3 or sub-channel 4. Additionally, the network entity and/or UE 804 may transmit the DL signals/UL signals to the first ZP-IoT device 806 using either sub-channel 1, sub-channel 2, sub-channel 3, or sub-channel 4.

In some cases, to limit the number of frequency hops that need to be performed when transmitting the DL signals/UL signals, a sub-channel hopping pattern may be used that indicates exactly which sub-channels to use for transmissions. For example, in some cases, the sub-channel hopping pattern may indicate a subset of sub-channels, of the plurality of sub-channels, to use to transmit the DL signals or UL signals to the first ZP-IoT device 806, the second ZP-IoT device 808, and the third ZP-IoT device 1802. For example, rather than using all four sub-channels to transmit the DL signals and UL signals, the sub-channel hopping pattern may indicate to use only sub-channel 1 and sub-channel 3 since these sub-channels are each included within at least one ZP-IoT frequency range supported by each of the first ZP-IoT device 806, the second ZP-IoT device 808, and the third ZP-IoT device 1802. In some cases, the configuration information transmitted in step 810 of FIG. 8 may indicate the sub-channel hopping pattern to use.

### Example Operations of a User Equipment

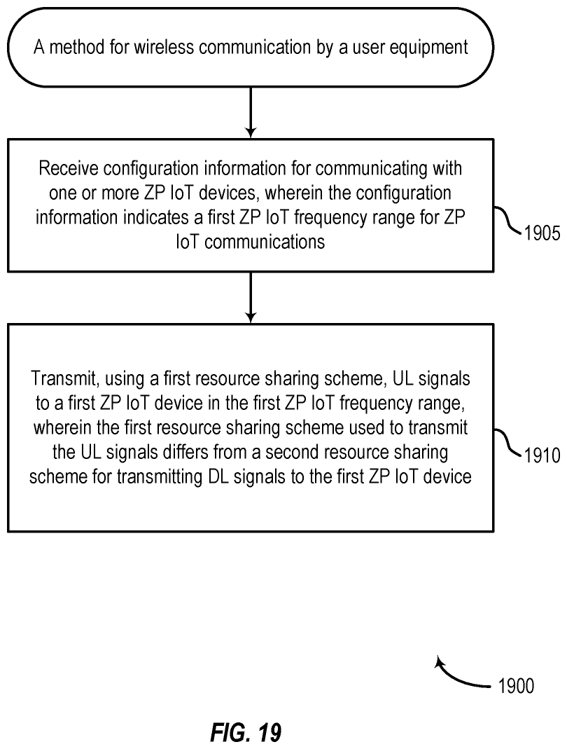

FIG. 19 shows an example of a method 1900 for wireless communication by a user equipment, such as a UE 104 of FIGS. 1 and 3.

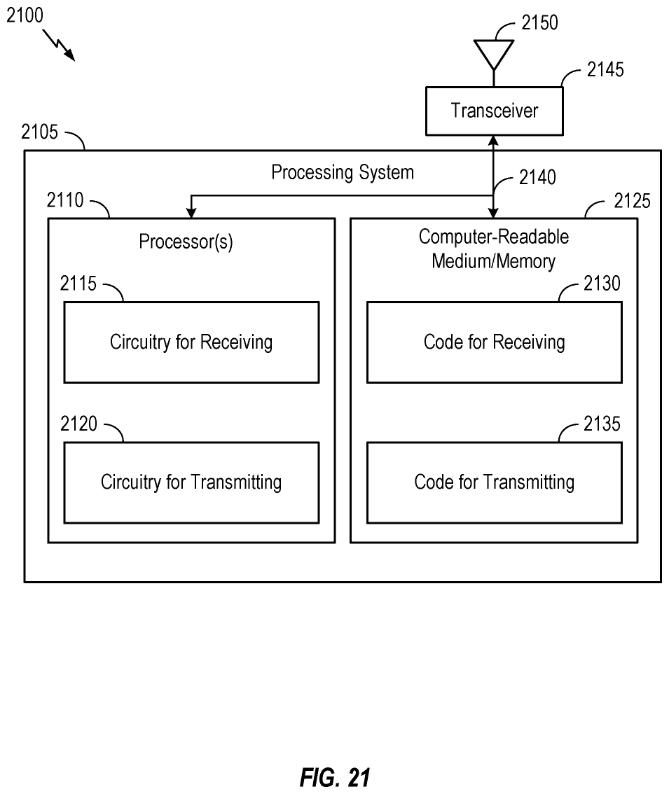

Method 1900 begins at step 1905 with receiving configuration information for communicating with one or more ZP IoT devices, wherein the configuration information indicates a first ZP IoT frequency range for ZP IoT communications. In some cases, the operations of this step refer to, or may be performed by, circuitry for receiving and/or code for receiving as described with reference to FIG. 21.

Method 1900 then proceeds to step 1910 with transmitting, using a first resource sharing scheme, UL signals to a first ZP IoT device in the first ZP IoT frequency range, wherein the first resource sharing scheme used to transmit the UL signals differs from a second resource sharing scheme for transmitting DL signals to the first ZP IoT device. In some cases, the operations of this step refer to, or may be performed by, circuitry for transmitting and/or code for transmitting as described with reference to FIG. 21.

In some aspects, transmitting the UL signals to the first ZP IoT device comprises transmitting the UL signals using a duplexing scheme.

In some aspects, the duplexing scheme comprises a TDD scheme in which the UL signals and the DL signals are separated into different time occasions; and the different time occasions comprise UL time occasions for the UL signals and DL time occasions for the DL signals.

In some aspects, for the UL time occasions, the first resource sharing scheme comprises an UL TDM scheme and an UL FDM scheme; and for the DL time occasions, the second resource sharing scheme comprises a DL TDM scheme and not a DL FDM scheme.

In some aspects, the configuration information includes an indication of a guard period configured between the UL signals to the first ZP IoT device in the UL time occasions and the DL signals to the first ZP IoT device in the DL time occasions.

In some aspects, the UL time occasions include: the first ZP IoT frequency range for the ZP IoT communications; and at least one frequency range for OFDM communications.

In some aspects, the duplexing scheme comprises a FDD scheme in which the UL signals and the DL signals are separated into different frequency bands within a time slot; and the different frequency ranges comprise an UL frequency band for the UL signals and a DL frequency band for the DL signals.

In some aspects, the first ZP IoT frequency range in which the UL signals are transmitted is included within the UL frequency band.

In some aspects, for the UL frequency band, the first resource sharing scheme comprises an UL TDM scheme and an UL FDM scheme; and for the DL frequency band, the second resource sharing scheme comprises a DL TDM scheme and not a DL FDM scheme.

In some aspects, transmitting the UL signals to the first ZP IoT device comprises one of: transmitting the UL signals to the first ZP IoT device without using an UL timing advance; or transmitting the UL signals to the first ZP IoT device using a first UL timing advance different from a second UL timing advance used for OFDM communications.

In some aspects, the method 1900 further includes transmitting the UL signals to one or more second ZP IoT devices. In some cases, the operations of this step refer to, or may be performed by, circuitry for transmitting and/or code for transmitting as described with reference to FIG. 21.

In some aspects, the one or more second ZP IoT devices support the ZP IoT communication in one or more additional ZP IoT frequency ranges different from the first ZP IoT frequency range; and the configuration information further indicates the one or more additional ZP IoT frequency ranges.

In some aspects, the first ZP IoT frequency range and the one or more additional ZP IoT frequency ranges are included within a ZP IoT bandwidth; the ZP IoT bandwidth includes a plurality of sub-channels; and each sub-channel of the plurality of sub-channels is included within at least one of the first ZP IoT frequency range or the one or more additional ZP IoT frequency ranges.

In some aspects, the configuration information further includes a sub-channel hopping pattern that indicates a subset of sub-channels, of the plurality of sub-channels, included within the first ZP IoT frequency range or the one or more additional ZP IoT frequency ranges to use to transmit the UL signals to the first ZP IoT device and the one or more second ZP IoT devices.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative steps are possible consistent with this disclosure.

### Example Operations of a Network Entity

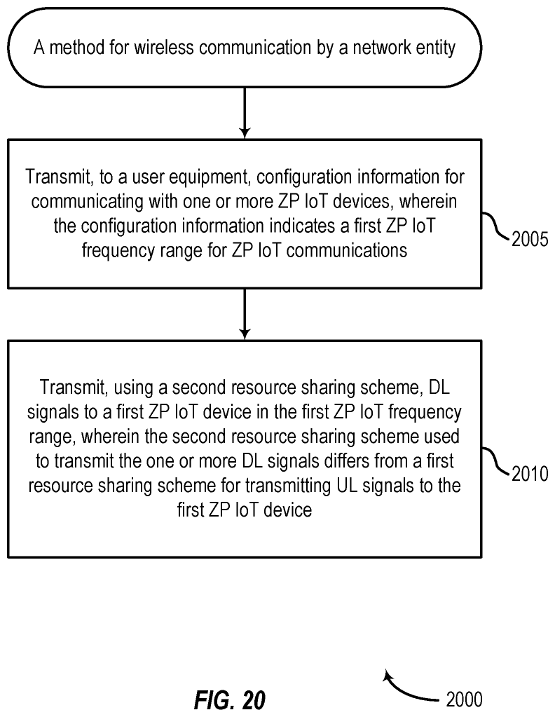

FIG. 20 shows an example of a method 2000 for wireless communication by a network entity, such as a BS 102 of FIGS. 1 and 3, or a disaggregated base station as discussed with respect to FIG. 2.

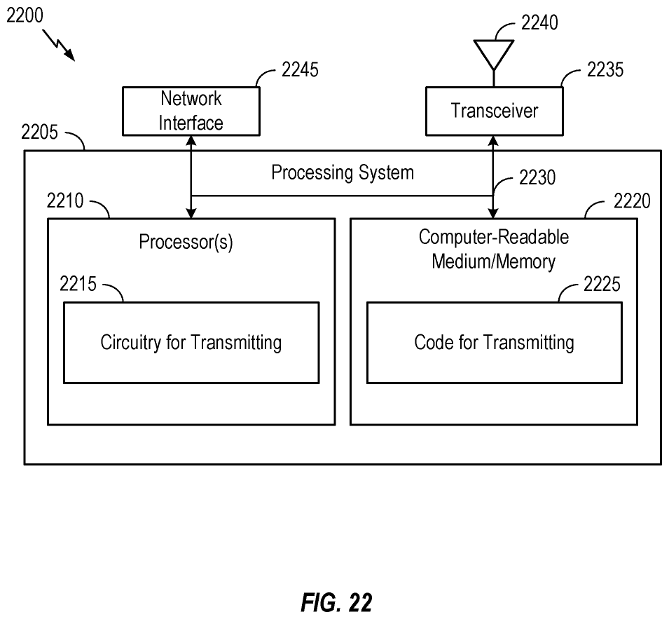

Method 2000 begins at step 2005 with transmitting, to a user equipment, configuration information for communicating with one or more ZP IoT devices, wherein the configuration information indicates a first ZP IoT frequency range for ZP IoT communications. In some cases, the operations of this step refer to, or may be performed by, circuitry for transmitting and/or code for transmitting as described with reference to FIG. 22.

Method 2000 then proceeds to step 2010 with transmitting, using a second resource sharing scheme, DL signals to a first ZP IoT device in the first ZP IoT frequency range, wherein the second resource sharing scheme used to transmit the one or more DL signals differs from a first resource sharing scheme for transmitting UL signals to the first ZP IoT device. In some cases, the operations of this step refer to, or may be performed by, circuitry for transmitting and/or code for transmitting as described with reference to FIG. 22.

In some aspects, transmitting the DL signals to the first ZP IoT device comprises transmitting the DL signals using a duplexing scheme.

In some aspects, the duplexing scheme comprises a TDD scheme in which the UL signals and the DL signals are separated into different time occasions; and the different time occasions comprise UL time occasions for the UL signals and DL time occasions for the DL signals.

In some aspects, for the UL time occasions, the first resource sharing scheme comprises an UL TDM scheme and an UL FDM scheme; and for the DL time occasions, the second resource sharing scheme comprises a DL TDM scheme and not a DL FDM scheme.

In some aspects, the configuration information includes an indication of a guard period configured between the UL signals to the first ZP IoT device in the UL time occasions and the DL signals to the first ZP IoT device in the DL time occasions.

In some aspects, the UL time occasions include: the first ZP IoT frequency range for the ZP IoT communications; and at least one frequency range for OFDM communications.

In some aspects, the duplexing scheme comprises a FDD scheme in which the UL signals and the DL signals are separated into different frequency bands within a time slot; and the different frequency ranges comprise an UL frequency band for the UL signals and a DL frequency band for the DL signals.

In some aspects, the first ZP IoT frequency range in which the DL signals are transmitted is included within the DL frequency band.

In some aspects, for the UL frequency band, the first resource sharing scheme comprises an UL TDM scheme and an UL FDM scheme; and for the DL frequency band, the second resource sharing scheme comprises a DL TDM scheme and not a DL FDM scheme.

In some aspects, the UL signals are further transmitted to one or more second ZP IoT devices.

In some aspects, the one or more second ZP IoT devices support the ZP IoT communication in one or more additional ZP IoT frequency ranges different from the first ZP IoT frequency range; and the configuration information further indicates the one or more additional ZP IoT frequency ranges.

In some aspects, the first ZP IoT frequency range and the one or more additional ZP IoT frequency ranges are included within a ZP IoT bandwidth; the ZP IoT bandwidth includes a plurality of sub-channels; and each sub-channel of the plurality of sub-channels is included within at least one of the first ZP IoT frequency range or the one or more additional ZP IoT frequency ranges.

In some aspects, the configuration information further includes a sub-channel hopping pattern that indicates a subset of sub-channels, of the plurality of sub-channels, included within the first ZP IoT frequency range or the one or more additional ZP IoT frequency ranges to use to transmit the UL signals to the first ZP IoT device and the one or more second ZP IoT devices.

In one aspect, method 2000, or any aspect related to it, may be performed by an apparatus, such as communications device 2200 of FIG. 22, which includes various components operable, configured, or adapted to perform the method 2000. Communications device 2200 is described below in further detail.

Note that FIG. 20 is just one example of a method, and other methods including fewer, additional, or alternative steps are possible consistent with this disclosure.

### Example Communications Devices

FIG. 21 depicts aspects of an example communications device 2100. In some aspects, communications device 2100 is a user equipment, such as a UE 104 described above with respect to FIGS. 1 and 3.

The communications device 2100 includes a processing system 2105 coupled to the transceiver 2145 (e.g., a transmitter and/or a receiver). The transceiver 2145 is configured to transmit and receive signals for the communications device 2100 via the antenna 2150, such as the various signals as described herein. The processing system 2105 may be configured to perform processing functions for the communications device 2100, including processing signals received and/or to be transmitted by the communications device 2100.

The processing system 2105 includes one or more processors 2110. In various aspects, the one or more processors 2110 may be representative of one or more of receive processor 358, transmit processor 364, TX MIMO processor 366, and/or controller/processor 380, as described with respect to FIG. 3. The one or more processors 2110 are coupled to a computer-readable medium/memory 2125 via a bus 2140. In certain aspects, the computer-readable medium/memory 2125 is configured to store instructions (e.g., computer-executable code) that when executed by the one or more processors 2110, cause the one or more processors 2110 to perform the method 1900 described with respect to FIG. 19, or any aspect related to it. Note that reference to a processor performing a function of communications device 2100 may include one or more processors 2110 performing that function of communications device 2100.

In the depicted example, computer-readable medium/memory 2125 stores code (e.g., executable instructions), such as code for receiving 2130 and code for transmitting 2135. Processing of the code for receiving 2130 and code for transmitting 2135 may cause the communications device 2100 to perform the method 1900 described with respect to FIG. 19, or any aspect related to it.

The one or more processors 2110 include circuitry configured to implement (e.g., execute) the code stored in the computer-readable medium/memory 2125, including circuitry such as circuitry for receiving 2115 and circuitry for transmitting 2120. Processing with circuitry for receiving 2115 and circuitry for transmitting 2120 may cause the communications device 2100 to perform the method 1900 described with respect to FIG. 19, or any aspect related to it.

Various components of the communications device 2100 may provide means for performing the method 1900 described with respect to FIG. 19, or any aspect related to it. For example, means for transmitting, sending or outputting for transmission may include transceivers 354 and/or antenna(s) 352 of the UE 104 illustrated in FIG. 3 and/or the transceiver 2145 and the antenna 2150 of the communications device 2100 in FIG. 21. Means for receiving or obtaining may include transceivers 354 and/or antenna(s) 352 of the UE 104 illustrated in FIG. 3 and/or the transceiver 2145 and the antenna 2150 of the communications device 2100 in FIG. 21.

FIG. 22 depicts aspects of an example communications device 2200. In some aspects, communications device 2200 is a network entity, such as a BS 102 of FIGS. 1 and 3, or a disaggregated base station as discussed with respect to FIG. 2.

The communications device 2200 includes a processing system 2205 coupled to the transceiver 2235 (e.g., a transmitter and/or a receiver) and/or a network interface 2245. The transceiver 2235 is configured to transmit and receive signals for the communications device 2200 via the antenna 2240, such as the various signals as described herein. The network interface 2245 is configured to obtain and send signals for the communications device 2200 via communication link(s), such as a backhaul link, midhaul link, and/or fronthaul link as described herein, such as with respect to FIG. 2. The processing system 2205 may be configured to perform processing functions for the communications device 2200, including processing signals received and/or to be transmitted by the communications device 2200.

The processing system 2205 includes one or more processors 2210. In various aspects, one or more processors 2210 may be representative of one or more of receive processor 338, transmit processor 320, TX MIMO processor 330, and/or controller/processor 340, as described with respect to FIG. 3. The one or more processors 2210 are coupled to a computer-readable medium/memory 2220 via a bus 2230. In certain aspects, the computer-readable medium/memory 2220 is configured to store instructions (e.g., computer-executable code) that when executed by the one or more processors 2210, cause the one or more processors 2210 to perform the method 2000 described with respect to FIG. 20, or any aspect related to it. Note that reference to a processor of communications device 2200 performing a function may include one or more processors 2210 of communications device 2200 performing that function.

In the depicted example, the computer-readable medium/memory 2220 stores code (e.g., executable instructions), such as code for transmitting 2225. Processing of the code for transmitting 2225 may cause the communications device 2200 to perform the method 2000 described with respect to FIG. 20, or any aspect related to it.

The one or more processors 2210 include circuitry configured to implement (e.g., execute) the code stored in the computer-readable medium/memory 2220, including circuitry such as circuitry for transmitting 2215. Processing with circuitry for transmitting 2215 may cause the communications device 2200 to perform the method 2000 as described with respect to FIG. 20, or any aspect related to it.

Various components of the communications device 2200 may provide means for performing the method 2000 as described with respect to FIG. 20, or any aspect related to it. Means for transmitting, sending or outputting for transmission may include transceivers 332 and/or antenna(s) 334 of the BS 102 illustrated in FIG. 3 and/or the transceiver 2235 and the antenna 2240 of the communications device 2200 in FIG. 22. Means for receiving or obtaining may include transceivers 332 and/or antenna(s) 334 of the BS 102 illustrated in FIG. 3 and/or the transceiver 2235 and the antenna 2240 of the communications device 2200 in FIG. 22.

### Example Clauses

Implementation examples are described in the following numbered clauses:

Clause 1: A method for wireless communication by a user equipment, comprising: receiving configuration information for communicating with one or more ZP IoT devices, wherein the configuration information indicates a first ZP IoT frequency range for ZP IoT communications; and transmitting, using a first resource sharing scheme, UL signals to a first ZP IoT device in the first ZP IoT frequency range, wherein the first resource sharing scheme used to transmit the UL signals differs from a second resource sharing scheme for transmitting DL signals to the first ZP IoT device.

Clause 2: The method of Clause 1, wherein transmitting the UL signals to the first ZP IoT device comprises transmitting the UL signals using a duplexing scheme.

Clause 3: The method of Clause 2, wherein: the duplexing scheme comprises a TDD scheme in which the UL signals and the DL signals are separated into different time occasions; and the different time occasions comprise UL time occasions for the UL signals and DL time occasions for the DL signals.

Clause 4: The method of Clause 3, wherein: for the UL time occasions, the first resource sharing scheme comprises an UL TDM scheme and an UL FDM scheme; and for the DL time occasions, the second resource sharing scheme comprises a DL TDM scheme and not a DL FDM scheme.

Clause 5: The method of Clause 4, wherein the configuration information includes an indication of a guard period configured between the UL signals to the first ZP IoT device in the UL time occasions and the DL signals to the first ZP IoT device in the DL time occasions.

Clause 6: The method of Clause 4, wherein the UL time occasions include: the first ZP IoT frequency range for the ZP IoT communications; and at least one frequency range for OFDM communications.

Clause 7: The method of Clause 2, wherein: the duplexing scheme comprises a FDD scheme in which the UL signals and the DL signals are separated into different frequency bands within a time slot; and the different frequency ranges comprise an UL frequency band for the UL signals and a DL frequency band for the DL signals.

Clause 8: The method of Clause 7, wherein the first ZP IoT frequency range in which the UL signals are transmitted is included within the UL frequency band.

Clause 9: The method of Clause 7, wherein: for the UL frequency band, the first resource sharing scheme comprises an UL TDM scheme and an UL FDM scheme; and for the DL frequency band, the second resource sharing scheme comprises a DL TDM scheme and not a DL FDM scheme.

Clause 10: The method of any one of Clauses 1-9, wherein transmitting the UL signals to the first ZP IoT device comprises one of: transmitting the UL signals to the first ZP IoT device without using an UL timing advance; or transmitting the UL signals to the first ZP IoT device using a first UL timing advance different from a second UL timing advance used for OFDM communications.

Clause 11: The method of any one of Clauses 1-10, further comprising: transmitting the UL signals to one or more second ZP IoT devices.

Clause 12: The method of Clause 11, wherein: the one or more second ZP IoT devices support the ZP IoT communication in one or more additional ZP IoT frequency ranges different from the first ZP IoT frequency range; and the configuration information further indicates the one or more additional ZP IoT frequency ranges.

Clause 13: The method of Clause 12, wherein: the first ZP IoT frequency range and the one or more additional ZP IoT frequency ranges are included within a ZP IoT bandwidth; the ZP IoT bandwidth includes a plurality of sub-channels; and each sub-channel of the plurality of sub-channels is included within at least one of the first ZP IoT frequency range or the one or more additional ZP IoT frequency ranges.

Clause 14: The method of Clause 13, wherein the configuration information further includes a sub-channel hopping pattern that indicates a subset of sub-channels, of the plurality of sub-channels, included within the first ZP IoT frequency range or the one or more additional ZP IoT frequency ranges to use to transmit the UL signals to the first ZP IoT device and the one or more second ZP IoT devices.

Clause 15: A method for wireless communication by a network entity, comprising: transmitting, to a user equipment, configuration information for communicating with one or more ZP IoT devices, wherein the configuration information indicates a first ZP IoT frequency range for ZP IoT communications; and transmitting, using a second resource sharing scheme, DL signals to a first ZP IoT device in the first ZP IoT frequency range, wherein the second resource sharing scheme used to transmit the one or more DL signals differs from a first resource sharing scheme for transmitting UL signals to the first ZP IoT device.

Clause 16: The method of Clause 15, wherein transmitting the DL signals to the first ZP IoT device comprises transmitting the DL signals using a duplexing scheme.

Clause 17: The method of Clause 16, wherein: the duplexing scheme comprises a TDD scheme in which the UL signals and the DL signals are separated into different time occasions; and the different time occasions comprise UL time occasions for the UL signals and DL time occasions for the DL signals.

Clause 18: The method of Clause 17, wherein: for the UL time occasions, the first resource sharing scheme comprises an UL TDM scheme and an UL FDM scheme; and for the DL time occasions, the second resource sharing scheme comprises a DL TDM scheme and not a DL FDM scheme.

Clause 19: The method of Clause 18, wherein the configuration information includes an indication of a guard period configured between the UL signals to the first ZP IoT device in the UL time occasions and the DL signals to the first ZP IoT device in the DL time occasions.

Clause 20: The method of Clause 18, wherein the UL time occasions include: the first ZP IoT frequency range for the ZP IoT communications; and at least one frequency range for OFDM communications.

Clause 21: The method of Clause 16, wherein: the duplexing scheme comprises a FDD scheme in which the UL signals and the DL signals are separated into different frequency bands within a time slot; and the different frequency ranges comprise an UL frequency band for the UL signals and a DL frequency band for the DL signals.

Clause 22: The method of Clause 21, wherein the first ZP IoT frequency range in which the DL signals are transmitted is included within the DL frequency band.

Clause 23: The method of Clause 21, wherein: for the UL frequency band, the first resource sharing scheme comprises an UL TDM scheme and an UL FDM scheme; and for the DL frequency band, the second resource sharing scheme comprises a DL TDM scheme and not a DL FDM scheme.

Clause 24: The method of any one of Clauses 15-23, wherein the UL signals are further transmitted to one or more second ZP IoT devices.

Clause 25: The method of Clause 24, wherein: the one or more second ZP IoT devices support the ZP IoT communication in one or more additional ZP IoT frequency ranges different from the first ZP IoT frequency range; and the configuration information further indicates the one or more additional ZP IoT frequency ranges.

Clause 26: The method of Clause 25, wherein: the first ZP IoT frequency range and the one or more additional ZP IoT frequency ranges are included within a ZP IoT bandwidth; the ZP IoT bandwidth includes a plurality of sub-channels; and each sub-channel of the plurality of sub-channels is included within at least one of the first ZP IoT frequency range or the one or more additional ZP IoT frequency ranges.

Clause 27: The method of Clause 26, wherein the configuration information further includes a sub-channel hopping pattern that indicates a subset of sub-channels, of the plurality of sub-channels, included within the first ZP IoT frequency range or the one or more additional ZP IoT frequency ranges to use to transmit the UL signals to the first ZP IoT device and the one or more second ZP IoT devices.

Clause 28: An apparatus, comprising: a memory comprising executable instructions; and a processor configured to execute the executable instructions and cause the apparatus to perform a method in accordance with any one of Clauses 1-27.

Clause 29: An apparatus, comprising means for performing a method in accordance with any one of Clauses 1-27.

Clause 30: A non-transitory computer-readable medium comprising executable instructions that, when executed by a processor of an apparatus, cause the apparatus to perform a method in accordance with any one of Clauses 1-27.

Clause 31: A computer program product embodied on a computer-readable storage medium comprising code for performing a method in accordance with any one of Clauses 1-27.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment, comprising:
receiving configuration information for communicating with one or more zero power internet of things (ZP-IoT) devices, wherein the configuration information indicates a first ZP-IoT frequency range for ZP-IoT communications; and
transmitting, using a first resource sharing scheme, uplink (UL) signals to a first ZP-IoT device in the first ZP-IoT frequency range, wherein the first resource sharing scheme used to transmit the UL signals differs from a second resource sharing scheme for transmitting downlink (DL) signals to the first ZP-IoT device.

2. The method of claim 1, wherein transmitting the UL signals to the first ZP-IoT device comprises transmitting the UL signals using a duplexing scheme.

3. The method of claim 2, wherein:
the duplexing scheme comprises a time division duplexing (TDD) scheme in which the UL signals and the DL signals are separated into different time occasions; and
the different time occasions comprise UL time occasions for the UL signals and DL time occasions for the DL signals.

4. The method of claim 3, wherein:
for the UL time occasions, the first resource sharing scheme comprises an UL time division multiplexing (TDM) scheme and an UL frequency division multiplexing (FDM) scheme; and
for the DL time occasions, the second resource sharing scheme comprises a DL TDM scheme and not a DL FDM scheme.

5. The method of claim 4, wherein the configuration information includes an indication of a guard period configured between the UL signals to the first ZP-IoT device in the UL time occasions and the DL signals to the first ZP-IoT device in the DL time occasions.

6. The method of claim 4, wherein the UL time occasions include:
the first ZP-IoT frequency range for the ZP-IoT communications; and
at least one frequency range for orthogonal frequency division multiplexing (OFDM) communications.

7. The method of claim 2, wherein:
the duplexing scheme comprises a frequency division duplexing (FDD) scheme in which the UL signals and the DL signals are separated into different frequency bands within a time slot; and
the different frequency ranges comprise an UL frequency band for the UL signals and a DL frequency band for the DL signals.

8. The method of claim 7, wherein the first ZP-IoT frequency range in which the UL signals are transmitted is included within the UL frequency band.

9. The method of claim 7, wherein:
for the UL frequency band, the first resource sharing scheme comprises an UL time division multiplexing (TDM) scheme and an UL frequency division multiplexing (FDM) scheme; and
for the DL frequency band, the second resource sharing scheme comprises a DL TDM scheme and not a DL FDM scheme.

10. The method of claim 1, wherein transmitting the UL signals to the first ZP-IoT device comprises one of:
transmitting the UL signals to the first ZP-IoT device without using an UL timing advance; or
transmitting the UL signals to the first ZP-IoT device using a first UL timing advance different from a second UL timing advance used for orthogonal frequency division multiplexing (OFDM) communications.

11. The method of claim 1, further comprising transmitting the UL signals to one or more second ZP-IoT devices.

12. The method of claim 11, wherein:
the one or more second ZP-IoT devices support the ZP-IoT communication in one or more additional ZP-IoT frequency ranges different from the first ZP-IoT frequency range; and
the configuration information further indicates the one or more additional ZP-IoT frequency ranges.

13. The method of claim 12, wherein:
the first ZP-IoT frequency range and the one or more additional ZP-IoT frequency ranges are included within a ZP-IoT bandwidth;
the ZP-IoT bandwidth includes a plurality of sub-channels; and
each sub-channel of the plurality of sub-channels is included within at least one of the first ZP-IoT frequency range or the one or more additional ZP-IoT frequency ranges.

14. The method of claim 13, wherein the configuration information further includes a sub-channel hopping pattern that indicates a subset of sub-channels, of the plurality of sub-channels, included within the first ZP-IoT frequency range or the one or more additional ZP-IoT frequency ranges to use to transmit the UL signals to the first ZP-IoT device and the one or more second ZP-IoT devices.

15. A method for wireless communication by a network entity, comprising:
transmitting, to a user equipment, configuration information for communicating with one or more zero power internet of things (ZP-IoT) devices, wherein the configuration information indicates a first ZP-IoT frequency range for ZP-IoT communications; and
transmitting, using a second resource sharing scheme, downlink (DL) signals to a first ZP-IoT device in the first ZP-IoT frequency range, wherein the second resource sharing scheme used to transmit the one or more DL signals differs from a first resource sharing scheme for transmitting uplink (UL) signals to the first ZP-IoT device.

16. The method of claim 15, wherein transmitting the DL signals to the first ZP-IoT device comprises transmitting the DL signals using a duplexing scheme.

17. The method of claim 16, wherein:
the duplexing scheme comprises a time division duplexing (TDD) scheme in which the UL signals and the DL signals are separated into different time occasions; and
the different time occasions comprise UL time occasions for the UL signals and DL time occasions for the DL signals.

18. The method of claim 17, wherein:
for the UL time occasions, the first resource sharing scheme comprises an UL time division multiplexing (TDM) scheme and an UL frequency division multiplexing (FDM) scheme; and
for the DL time occasions, the second resource sharing scheme comprises a DL TDM scheme and not a DL FDM scheme.

19. The method of claim 18, wherein the configuration information includes an indication of a guard period configured between the UL signals to the first ZP-IoT device in the UL time occasions and the DL signals to the first ZP-IoT device in the DL time occasions.

20. The method of claim 18, wherein the UL time occasions include:
the first ZP-IoT frequency range for the ZP-IoT communications; and
at least one frequency range for orthogonal frequency division multiplexing (OFDM) communications.

21. The method of claim 16, wherein:
the duplexing scheme comprises a frequency division duplexing (FDD) scheme in which the UL signals and the DL signals are separated into different frequency bands within a time slot; and
the different frequency ranges comprise an UL frequency band for the UL signals and a DL frequency band for the DL signals.

22. The method of claim 21, wherein the first ZP-IoT frequency range in which the DL signals are transmitted is included within the DL frequency band.

23. The method of claim 21, wherein:
for the UL frequency band, the first resource sharing scheme comprises an UL time division multiplexing (TDM) scheme and an UL frequency division multiplexing (FDM) scheme; and
for the DL frequency band, the second resource sharing scheme comprises a DL TDM scheme and not a DL FDM scheme.

24. The method of claim 15, wherein the UL signals are further transmitted to one or more second ZP-IoT devices.

25. The method of claim 24, wherein:
the one or more second ZP-IoT devices support the ZP-IoT communication in one or more additional ZP-IoT frequency ranges different from the first ZP-IoT frequency range; and
the configuration information further indicates the one or more additional ZP-IoT frequency ranges.

26. The method of claim 25, wherein:
the first ZP-IoT frequency range and the one or more additional ZP-IoT frequency ranges are included within a ZP-IoT bandwidth;
the ZP-IoT bandwidth includes a plurality of sub-channels; and
each sub-channel of the plurality of sub-channels is included within at least one of the first ZP-IoT frequency range or the one or more additional ZP-IoT frequency ranges.

27. The method of claim 26, wherein the configuration information further includes a sub-channel hopping pattern that indicates a subset of sub-channels, of the plurality of sub-channels, included within the first ZP-IoT frequency range or the one or more additional ZP-IoT frequency ranges to use to transmit the UL signals to the first ZP-IoT device and the one or more second ZP-IoT devices.

28. A user equipment (UE), comprising:
a memory comprising executable instructions; and
a processor configured to execute the executable instructions and cause the apparatus to:
receive configuration information for communicating with one or more zero power internet of things (ZP-IoT) devices, wherein the configuration information indicates a first ZP-IoT frequency range for ZP-IoT communications; and
transmit, using a first resource sharing scheme, uplink (UL) signals to a first ZP-IoT device in the first ZP-IoT frequency range, wherein the first resource sharing scheme used to transmit the UL signals differs from a second resource sharing scheme for transmitting downlink (DL) signals to the first ZP-IoT device.

29. A network entity, comprising:
a memory comprising executable instructions; and
a processor configured to execute the executable instructions and cause the apparatus to:
transmitting, to a user equipment, configuration information for communicating with one or more zero power internet of things (ZP-IoT) devices, wherein the configuration information indicates a first ZP-IoT frequency range for ZP-IoT communications; and
transmitting, using a second resource sharing scheme, downlink (DL) signals to a first ZP-IoT device in the first ZP-IoT frequency range, wherein the second resource sharing scheme used to transmit the one or more DL signals differs from a first resource sharing scheme for transmitting uplink (UL) signals to the first ZP-IoT device.
